(19) United States
(12) Patent Application Publication
(10) Pub. No.: US 2008/0123019 A1
(43) Pub. Date: May 29, 2008

(54) LIGHT DIFFUSER PLATE, SURFACE EMISSION LIGHT SOURCE APPARATUS AND LIQUID CRYSTAL DISPLAY

(75) Inventors: Hisanori OKU, Niihama-shi (JP); Hironobu Iyama, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/943,637

(22) Filed: Nov. 21, 2007

(30) Foreign Application Priority Data
Nov. 24, 2006 (JP) 2006-316965
Mar. 28, 2007 (JP) 2007-083287

(51) Int. Cl. F21V 11/00; F21V 1/00; G02F 1/1335

(52) U.S. Cl. 349/64; 362/235; 362/355

(57) ABSTRACT

The present invention provides a light diffuser plate, a surface emission light source apparatus and a liquid crystal display apparatus which are capable of preventing the generation of annoying noise in an area of contact between the light diffuser plate and a lamp box.

The present invention relates to a surface emission light source apparatus comprising a plurality of light sources disposed at a distance from each other in a lamp box, that is made of a resin and has an open front side, and a light diffuser plate that is made of a resin and is disposed on the front side of the frame of the lamp box so as to close the opening of the lamp box, wherein at least a part of the back surface of the light diffuser plate that makes contact with the front surface of the frame is formed as a matted surface, the matted surface has an arithmetic mean surface roughness Ra in a range from 0.8 to 15 μm and a mean surface irregularity interval Rsm in a range from 100 to 300 μm.

### BACKGROUND OF THE INVENTION

1. Field of the Invention

The present invention relates to a light diffuser plate, a surface emission light source apparatus and a liquid crystal display apparatus which are capable of preventing the generation of annoying noise in an area of contact between the light diffuser plate and a lamp box.

In this specification and the claims, the term “arithmetic mean surface roughness Ra” means the arithmetic mean surface roughness Ra measured according to JIS B0601-1994, and the term “mean surface irregularity interval Rsm” means the mean surface irregularity interval Rsm measured according to JIS B0601-1994.

2. Description of the Related Art

Such a liquid crystal display apparatus is known, for example, that has a surface emission light source apparatus disposed as the backlight on the lower surface (back surface) of a display section that comprises liquid crystal cell and a pair of polarizer plates disposed on the top and bottom sides of the liquid crystal cell. For the surface emission light source apparatus used as the backlight, such a constitution is known as a plurality of light sources is disposed in a lamp box, and a light diffuser plate is disposed on the front side of the light sources (refer to Japanese Unexamined Patent Publication (Kokai) No. 7-141908 (paragraph [0012] and FIG. 1)).

The light diffuser plate described above is fastened in the state of making contact with the front surface of the frame of the lamp box, and therefore annoying noise may be generated as the front surface of the frame and the light diffuser plate rub against each other. For example, when the power supply is turned on, the light diffuser plate expands due to rising temperature within the surface emission light source apparatus, thus resulting in the generation of annoying noise as the front surface of the frame and the light diffuser plate rub against each other. Generation of annoying noise is conspicuous in the case where the frame of the lamp box is made of polycarbonate.

### SUMMARY OF THE INVENTION

The present invention has been conceived with the background described above, and has an object of providing a light diffuser plate, a surface emission light source apparatus and a liquid crystal display apparatus that are capable of preventing the generation of annoying noise from the area of contact between the light diffuser plate and the lamp box.

In order to achieve the objects described above, the present invention provides the following means.

[1] A surface emission light source apparatus comprising a plurality of light sources disposed at a distance from each other in a lamp box, that is made of a resin and has an open front side, and a light diffuser plate that is made of a resin and is disposed on the front side of the frame of the lamp box so as to close the opening of the lamp box, wherein at least a part of the back surface of the light diffuser plate that makes contact with the front surface of the frame is formed as a matted surface, the matted surface has an arithmetic mean surface roughness Ra in a range from 0.8 to 15 μm and a mean surface irregularity interval Rsm in a range from 100 to 300 μm.
[2] The surface emission light source apparatus according to paragraph [1], wherein a plurality of triangular ridges having a triangular cross section is disposed to protrude on the front surface of the light diffuser plate, while the vertex angle of the triangular ridges is set in a range from 40 to 150 degrees and the pitch between adjacent triangular ridges is set in a range from 10 to 500 μm.
[3] The surface emission light source apparatus according to paragraph [1], wherein a plurality of substantially semicircular ridges having a substantially semicircular cross section is formed to protrude on the front surface of the light diffuser plate, the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.
[4] A surface emission light source apparatus comprising a plurality of light sources disposed at a distance from each other in a lamp box, that is made of a resin and has an open front side, and a light diffuser plate that is made of a resin and is disposed on the front side of the frame of the lamp box so as to close the opening of the lamp box, wherein the entire back surface of the light diffuser plate is formed as a matted surface, the matted surface has an arithmetic mean surface roughness Ra in a range from 0.8 to 15 μm and a mean surface irregularity interval Rsm in a range from 100 to 300 μm.
[5] The surface emission light source apparatus according to paragraph [4], wherein a plurality of triangular ridges having a triangular cross section is disposed to protrude on the front surface of the light diffuser plate, while the vertex angle of the triangular ridges is set in a range from 40 to 150 degrees, and the pitch between adjacent triangular ridges is set in a range from 10 to 500 μm.
[6] The surface emission light source apparatus according to paragraph [4], wherein a plurality of substantially semicircular ridges having a substantially semicircular cross section is formed to protrude on the front surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.
[7] The surface emission light source apparatus according to paragraph [2] or [5], wherein the triangular ridges are ridges of prism shape, the light sources are linear light sources, and the ridges of prism shape are disposed so that the longitudinal direction thereof substantially agrees with the longitudinal direction of the linear light sources.
[8] The surface emission light source apparatus according to paragraph [3] or [6], wherein the substantially semicircular ridges are ridges of cylindrical lens shape, the light sources are linear light sources, and the ridges of cylindrical lens shape are disposed so that the longitudinal direction thereof substantially agrees with the longitudinal direction of the linear light sources.

### [9] The surface emission light source apparatus according to any one of paragraphs [1] to [8], wherein total light transmittance of the light diffuser plate is in a range from 55 to 85%.

### [10] A liquid crystal display apparatus comprising the surface emission light source apparatus according to any one of paragraphs [1] to [9] and a liquid crystal display panel disposed on the front side of the surface emission light source apparatus.

[11] A light diffuser plate made of a resin with at least a peripheral portion of one surface thereof being formed as a matted surface, wherein the matted surface has an arithmetic mean surface roughness Ra in a range from 0.8 to 15 μm and a mean surface irregularity interval Rsm in a range from 100 to 300 μm.
[12] The light diffuser plate according to paragraph [11], wherein a plurality of triangular ridges having a triangular cross section is disposed to protrude on the other surface of the light diffuser plate, the triangular ridges have a vertex angle set in a range from 40 to 150 degrees and the pitch between adjacent triangular ridges is set in a range from 10 to 500 μm.
[13] The light diffuser plate according to paragraph [11], wherein a plurality of substantially semicircular ridges having a substantially semicircular cross section is formed to protrude on the other surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.
[14] A light diffuser plate made of a resin with the entire surface on one surface thereof being formed as a matted surface, wherein the matted surface has an arithmetic mean surface roughness Ra in a range from 0.8 to 15 μm and a mean surface irregularity interval Rsm in a range from 100 to 300 μm.
[15] The light diffuser plate according to paragraph [14], wherein a plurality of triangular ridges having a triangular cross section is disposed to protrude on the other surface of the light diffuser plate, while the triangular ridges have a vertex angle set in a range from 40 to 150 degrees and the pitch between adjacent triangular ridges is set in a range from 10 to 500 μm.
[16] The light diffuser plate according to paragraph [14], wherein a plurality of substantially semicircular ridges having a substantially semicircular cross section is formed to protrude on the other surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.

According to the invention according to paragraph [1], at least a part of the back surface of the light diffuser plate that makes contact with the front surface of the frame is formed as a matted surface, while the matted surface has an arithmetic mean surface roughness Ra in a range from 0.8 to 15 μm and a mean surface irregularity interval Rsm in a range from 100 to 300 μm, and therefore generation of annoying noise when the front surface of the frame of the lamp box and the light diffuser plate rub against each other can be prevented. Generation of annoying noise is conspicuous in the case where the frame of the lamp box is made of polycarbonate in the constitution of the prior art. According to the present invention, in contrast, generation of the annoying noise can be satisfactorily prevented even when the frame of the lamp box is made of polycarbonate.

According to the invention according to paragraph [2], a plurality of triangular ridges having a triangular cross section is disposed to protrude on the front surface of the light diffuser plate, while the triangular ridges have a vertex angle set in a range from 40 to 150 degrees and the pitch between adjacent triangular ridges set in a range from 10 to 500 μm, and therefore luminance of emitted light can be increased.

According to the invention according to paragraph [3], a plurality of substantially semicircular ridges having a substantially semicircular cross section is formed to protrude on the front surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8, and therefore luminance of emitted light can be increased.

According to the invention according to paragraph [4], the entire surface on the back surface of the light diffuser plate is formed as a matted surface, while the matted surface has an arithmetic mean surface roughness Ra in a range from 0.8 to 15 μm and a mean surface irregularity interval Rsm in a range from 100 to 300 μm, and therefore generation of annoying noise when the front surface of the frame of the lamp box and the light diffuser plate rub against each other can be prevented. Generation of annoying noise is conspicuous in case the frame of the lamp box is made of polycarbonate in the constitution of the prior art. According to the present invention, in contrast, generation of the annoying noise can be satisfactorily prevented even when the frame of the lamp box is made of polycarbonate. This constitution having the entire surface on the back surface of the light diffuser plate being formed as a matted surface makes it possible to improve manufacturing efficiency and makes it easier to switch the product to be manufactured to a different size.

According to the invention according to paragraph [5], a plurality of triangular ridges having a triangular cross section is disposed to protrude on the front surface of the light diffuser plate, while the triangular ridges have a vertex angle set in a range from 40 to 150 degrees and the pitch between adjacent triangular ridges set in a range from 10 to 500 μm, and therefore luminance of emitted light can be increased. Moreover, due to the synergistic effect of forming the entire surface on the back surface of the light diffuser plate as a specific matted surface and providing the triangular ridges having a particular configuration to protrude on the front surface of the light diffuser plate, light can be emitted uniformly without unevenness in luminance. The synergistic effect of suppressing the unevenness in luminance becomes greater when the light diffuser plate is formed in such a constitution that has high total light transmittance (for example, from 55 to 75%).

In the case where the triangular ridges (particularly triangular ridges having a vertex angle of 90 degrees) are disposed on the front surface of the light diffuser plate, light incident on the front surface of the light diffuser plate in the normal direction thereof is totally reflected back toward the back surface (light source), and therefore the light diffuser plate has a low diffusion rate. According to the invention of [4], in contrast, since the entire surface on the back surface of the light diffuser plate is formed as a matted surface with an arithmetic mean surface roughness Ra in a range from 0.8 to 15 μm and a mean surface irregularity interval Rsm in a range from 100 to 300 μm, even the light incident on the front surface of the light diffuser plate in the normal direction can be sufficiently diffused. As a result, the light can be emitted toward the front while being diffused without being totally reflected on the front surface of the light diffuser plate, and therefore the effect of the light diffuser plate to diffuse light can be improved. That is, due to the synergistic effect of forming the entire surface on the back surface of the light diffuser plate as a specific matted surface and providing the triangular ridges having a particular configuration on the front surface of the light diffuser plate, the effect of the light diffuser plate to diffuse light can also be improved. The synergistic effect becomes particularly significant when the light diffuser plate includes a light diffusing agent (light diffusing particles). A light diffuser plate that includes a light diffusing agent (light diffusing particles) having a particle size of sub-micrometer order, for example, tends to transmit an image of the profile of the light source (lamp) tinged with a color forward so as to be observed from the outside. According to the invention of [4], in contrast, the image of the profile of the light source can be satisfactorily suppressed from being observed from the outside, due to the synergistic effect described above.

According to the invention according to paragraph [6], a plurality of substantially semicircular ridges having a substantially semicircular cross section is formed to protrude on the front surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8, and therefore luminance of emitted light can be increased.

Moreover, due to the synergistic effect of forming the entire surface on the back surface of the light diffuser plate as a specific matted surface and providing the substantially semicircular ridges having a particular configuration to protrude on the front surface of the light diffuser plate, light can be emitted uniformly without unevenness in luminance. The synergistic effect of suppressing the unevenness in luminance becomes greater when the light diffuser plate is in such a constitution that has high total light transmittance (for example, from 55 to 85%). The synergistic effect becomes particularly significant when the light diffuser plate includes a light diffusing agent (light diffusing particles). A light diffuser plate that includes a light diffusing agent (light diffusing particles) having a particle size of sub-micrometer order, for example, tends to transmit an image of the profile of the light source (lamp) tinged with a color forward so as to be observed from the outside. According to the invention of [2], in contrast, the image of the profile of the light source can be satisfactorily suppressed from being observed from the outside due to the synergistic effect described above.

According to the invention according to paragraph [7], since the ridges having prism shape are disposed so that the longitudinal direction thereof substantially agrees with the longitudinal direction of the linear light sources, there is provided such an advantage that the image of the light sources that has transmitted through the light diffuser plate is spread in a direction perpendicular to the longitudinal direction of the linear light sources so as to improve the uniformity of luminance within the surface.

According to the invention according to paragraph [8], since the ridges having cylindrical lens shape are disposed so that the longitudinal direction thereof substantially agrees with the longitudinal direction of the linear light sources, there is provided such an advantage that the image of the light sources that has transmitted through the light diffuser plate is spread in a direction perpendicular to the longitudinal direction of the linear light sources so as to improve the uniformity of luminance within the surface.

According to the invention according to paragraph [9], since the total light transmittance of the light diffuser plate is in a range from 55 to 85%, a sufficient level of luminance as well as a sufficient effect of suppressing the unevenness in luminance by the above-mentioned synergistic effect can be obtained.

According to the invention according to paragraph [10], the liquid crystal display apparatus capable of preventing the generation of annoying noise in an area of contact between the light diffuser plate and the lamp box is provided.

The invention (light diffuser plate) according to paragraph [11] comprises the light diffuser plate made of a resin with at least a peripheral portion of one surface thereof being formed as a matted surface, while the matted surface has an arithmetic mean surface roughness Ra in a range from 0.8 to 15 μm and a mean surface irregularity interval Rsm in a range from 100 to 300 μm, and therefore the generation of annoying noise when the front surface of the frame of the lamp box and the light diffuser plate rub against each other can be prevented.

According to the invention according to paragraph [12], a plurality of triangular ridges having a triangular cross section is disposed to protrude on the other surface of the light diffuser plate, while the triangular ridges have a vertex angle set in a range from 40 to 150 degrees and the pitch between adjacent triangular ridges set in a range from 10 to 500 μm, and therefore luminance of emitted light can be increased.

According to the invention according to paragraph [13], a plurality of substantially semicircular ridges having a substantially semicircular cross section is formed to protrude on the other surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8, and therefore luminance of emitted light can be increased.

According to the invention according to paragraph [14], the entire surface of one surface of the light diffuser plate is formed as a matted surface, while the matted surface has an arithmetic mean surface roughness Ra in a range from 0.8 to 15 μm and a mean surface irregularity interval Rsm in a range from 100 to 300 μm, and therefore the generation of annoying noise when the front surface of the frame of the lamp box and the light diffuser plate rub against each other can be prevented. Also this constitution having the entire surface of one surface of the light diffuser plate being formed as a matted surface makes it possible to improve manufacturing efficiency and makes it easier to switch the product to be manufactured to a different size.

According to the invention according to paragraph [15], a plurality of triangular ridges having a triangular cross section is disposed to protrude on the other surface of the light diffuser plate, while the triangular ridges have a vertex angle set in a range from 40 to 150 degrees and the pitch between adjacent triangular ridges set in a range from 10 to 500 μm, and therefore luminance of emitted light can be increased. Moreover, due to the synergistic effect of forming the entire surface of one surface of the light diffuser plate as a specific matted surface and providing the triangular ridges having a particular configuration to protrude on the other surface of the light diffuser plate, light can be emitted uniformly without unevenness in luminance and the effect of the light diffuser plate to diffuse light can be sufficiently improved.

According to the invention according to paragraph [16], a plurality of substantially semicircular ridges having a substantially semicircular cross section is formed to protrude on the other surface of the light diffuser plate, while the pitch (P) between adjacent semicircular ridges is set in a range from 10 to 500 μm, the height H of the substantially semicircular ridges is set in a range from 3 to 500 μm, and the ratio (H/P) of the height to the pitch is set in a range from 0.2 to 0.8, and therefore luminance of emitted light can be increased.

Moreover, due to the combined effect of forming the entire surface of one surface of the light diffuser plate as a specific matted surface and providing the substantially semicircular ridges having a particular configuration to protrude on the other surface of the light diffuser plate, light can be emitted uniformly without unevenness in luminance and the effect of the light diffuser plate to diffuse light can be sufficiently improved.

### BRIEF DESCRIPTION OF THE DRAWINGS

FIG. 1 schematically shows one embodiment of the liquid crystal display apparatus according to the present invention.

FIG. 2 is a schematic perspective view showing one embodiment of the light diffuser plate according to the present invention.

FIG. 3 is a schematic sectional view of the light diffuser plate shown in FIG. 2.

FIG. 4 is a schematic sectional view showing another embodiment of the light diffuser plate according to the present invention.

FIG. 5 is a schematic sectional view showing further another embodiment of the light diffuser plate according to the present invention.

FIG. 6 is a schematic sectional view showing further another embodiment of the light diffuser plate according to the present invention.

FIG. 7 is a graph showing the results of measuring spectral transmittance. Example A4 is drawn with a solid line, Example A5 is drawn with a dashed line, Comparative Example A2 is drawn with an alternate long and short dashes line, and Comparative Example A3 is drawn with an alternate long and two short dashes line.

FIG. 8 schematically shows one embodiment of the liquid crystal display apparatus according to the present invention.

FIG. 9 is a schematic perspective view showing one embodiment of the light diffuser plate according to the present invention.

FIG. 10 is a schematic sectional view of the light diffuser plate shown in FIG. 9.

FIG. 11 is a schematic sectional view showing another embodiment of the light diffuser plate according to the present invention.

FIG. 12 is a schematic sectional view showing further another embodiment of the light diffuser plate according to the present invention.

FIG. 13 is a schematic sectional view showing further another embodiment of the light diffuser plate according to the present invention.

FIG. 14 is a schematic sectional view showing further another embodiment of the light diffuser plate according to the present invention.

### BRIEF DESCRIPTION OF THE REFERENCE NUMERALS

1 Surface emission light source apparatus
1′ Surface emission light source apparatus
2 Light source
3 Light diffuser plate
3a Back surface (One surface)
3b Front surface (Other surface)
3′ Light diffuser plate
3a′ Back surface (One surface)
3b′ Front surface (Other surface)
5 Lamp box
6 Matted surface
7 Triangular ridge
7′ Substantially semicircular ridge
8′ Cylindrical lens (Ridge)
10 Liquid crystal panel
20 Liquid crystal display apparatus
20′ Liquid crystal display apparatus
31 Frame (Side surface plate)
31a Front surface (Front surface face side end face of side surface plate)
α Vertex angle of triangular ridge
P Pitch between adjacent triangular ridges
H Height of substantially semicircular ridges
P′ Pitch between adjacent substantially semicircular ridges

### DETAILED DESCRIPTION OF THE INVENTION

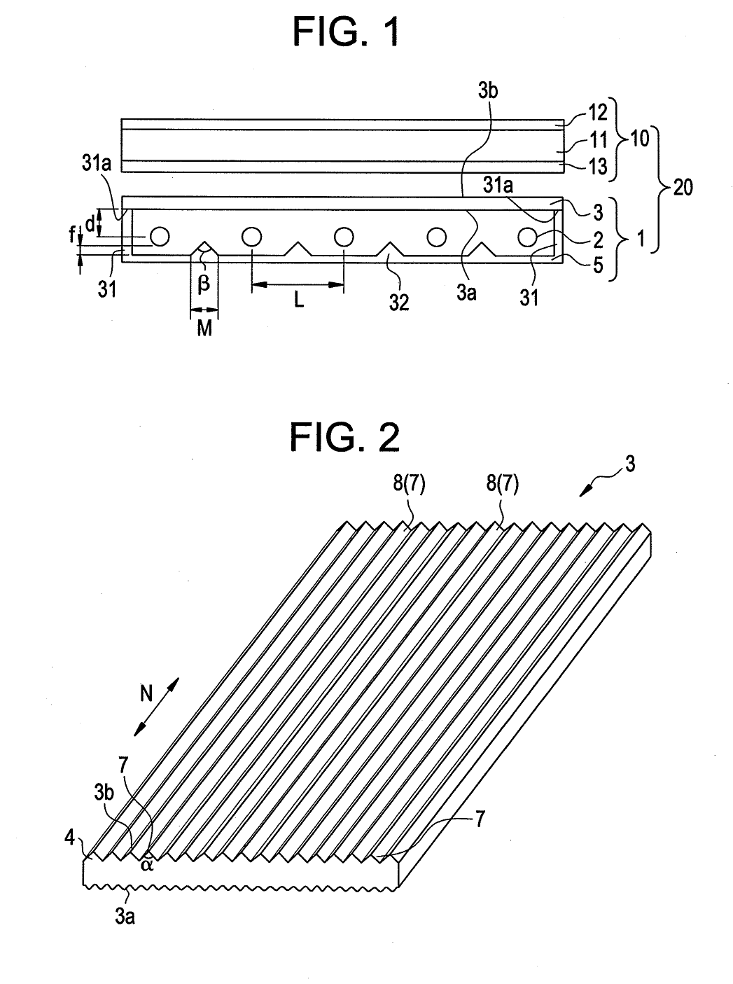

One embodiment (embodiment A) of the liquid crystal display apparatus according to the present invention is shown in FIG. 1. In FIG. 1, reference numeral (1) denotes a surface emission light source apparatus (backlight), (10) denotes a liquid crystal display panel and (20) denotes a liquid crystal display apparatus. The liquid crystal display panel (10) comprises a liquid crystal cell (11) and polarizer plates (12), (13) disposed on top and bottom sides of the liquid crystal cell (11).

The surface emission light source apparatus (1) is disposed on the lower surface side (back surface side) of the bottom side polarizer plate (13) of the liquid crystal panel (10). The surface emission light source apparatus (1) comprises a lamp box (5) of a low-profile box configuration having a rectangular shape in plan view that is open on the front side (top), a plurality of linear light sources (2) disposed at a distance from each other in the lamp box (5), and a light diffuser plate (3) made of a resin disposed on the front side (top) of the plurality of linear light sources (2). The lamp box (5) has such a constitution as a frame (31) comprising a side plate extending from the periphery of a back plate (32) of rectangular shape in plan view toward the front, and has an aperture on the front side as shown in FIG. 1. The light diffuser plate (3) is secured onto the lamp box (5) so as to close the opening on the front side of the lamp box. The light diffuser plate (3) is fastened onto the lamp box (5) in such a state as the peripheral portion of a back surface (3a) of the light diffuser plate (3) makes contact with a front surface (31a) of the frame (31) of the lamp box (5). The lamp box (5) is lined with a reflector layer (not shown) on the inside thereof.

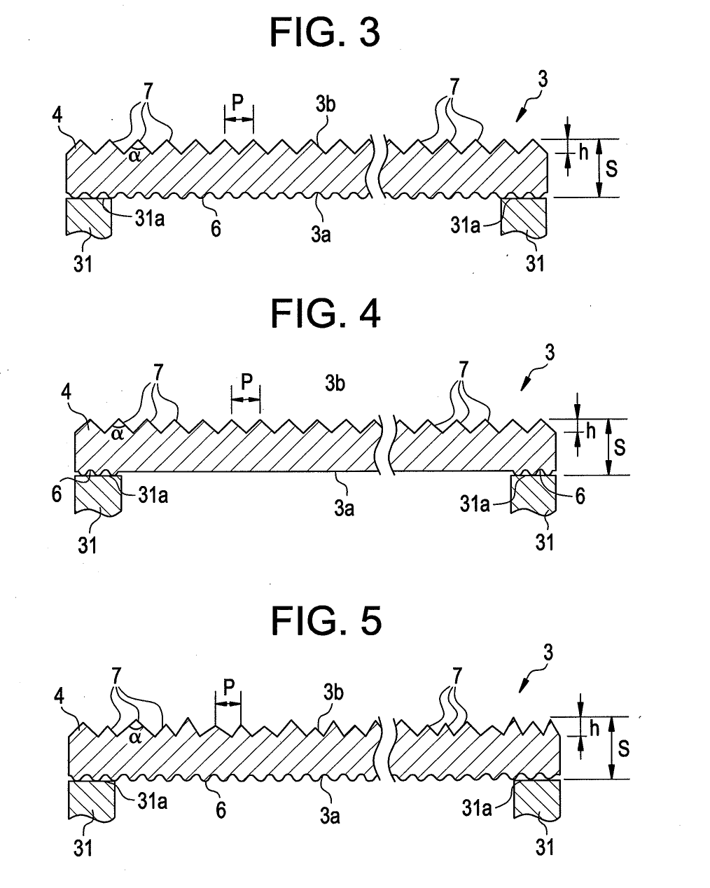

The light diffuser plate (3) is made of a resin with the entire surface on the back surface (3a) thereof being formed as a matted surface (6) as shown in FIG. 3. That is, the light diffuser plate (3) is disposed so that the surface (3a) of the light diffuser plate (3) formed as the matted surface (6) is on the side of the light source (2) (refer to FIG. 1). The matted surface (6) has an arithmetic mean surface roughness Ra in a range from 0.8 to 15 μm and a mean surface irregularity interval Rsm in a range from 100 to 300 μm. While the entire surface on the back surface (3a) of the light diffuser plate (3) is formed as the matted surface (6) in embodiment A, the present invention is not limited to this constitution. It suffices that at least a part of the back surface (3a) of the light diffuser plate (3) that makes contact with the front surface (31a) of the frame is formed as the matted surface (6). For example, such a constitution may be employed as only the part of the back surface (3a) of the light diffuser plate (3) that makes contact with the front surface (31a) of the frame is formed as the matted surface (6), as shown in FIG. 4.

In embodiment A, a rugged surface section (4) comprising a plurality of triangular ridges (7) having triangular cross section is formed on a front surface (3b) of the light diffuser plate (3). That is, the surface (3b) of the light diffuser plate (3) whereon the triangular ridges (7) are formed is disposed on the side of the liquid crystal display panel (10) (refer to FIG. 1). The vertex angle (α) of the triangular ridges (7) is set in a range from 40 to 150 degrees, and the pitch (P) between adjacent triangular ridges (7) is set in a range from 10 to 500 μm. Also in embodiment A, cross section of the triangular ridges (7) has a shape of an isosceles triangle where the two sides that form the vertex angle (α) are equal.

Also in embodiment A, the triangular ridges (7) are constituted from ridges of prism shape (ridges having triangular cross section) (8) formed to extend in one direction parallel to the surface of the light diffuser plate (3), and these ridges of prism shape (8) are disposed substantially parallel to each other in the longitudinal direction thereof (refer to FIG. 2).

Also in embodiment A, linear light sources are used as the light sources (2), while the longitudinal direction of the light sources (2) and the longitudinal direction of the ridges of prism shape (8) of the light diffuser plate (3) substantially coincide. Also the ridges of prism shape (8) are disposed so that the longitudinal direction thereof substantially agrees with the longitudinal direction (N) of the light diffuser plate (3) (refer to FIG. 2).

In the surface emission light source apparatus (1) having the constitution described above, at least a part of the back surface (3a) of the light diffuser plate (3) that makes contact with the front surface (31a) of the frame of the lamp box (5) is formed as the matted surface (6), while the matted surface (6) has an arithmetic mean surface roughness Ra in a range from 0.8 to 15 μm and a mean surface irregularity interval Rsm in a range from 100 to 300 μm. Therefore, the front surface (31a) of the frame of the lamp box (5) and the light diffuser plate (3) are put into point contact or near point contact so as to reduce the friction therebetween, thereby to prevent the generation of annoying noise when the front surface (31a) of the frame of the lamp box (5) and the light diffuser plate (3) rub against each other.

Further in embodiment A, since the plurality of triangular ridges (7) having triangular cross section is formed to protrude on the front surface (3b) of the light diffuser plate (3), the vertex angle (α) of the triangular ridges (7) is set in a range from 40 to 150 degrees, and the pitch (P) between adjacent semicircular ridges (7) is set in a range from 10 to 500 μm, luminance of emitted light can be sufficiently increased.

Additionally in embodiment A, due to the synergistic effect of forming the entire surface on the back surface (3a) of the light diffuser plate (3) as the matted surface (6) an having arithmetic mean surface roughness Ra in a range from 0.8 to 15 μm and a mean surface irregularity interval Rsm in a range from 100 to 300 μm, and forming the triangular ridges (7) to protrude on the front surface (3b) of the light diffuser plate (3), light can be emitted uniformly without unevenness in luminance, namely high uniformity of luminance can be achieved over the surface. The extent to which uniformity of luminance can be improved over the surface varies depending on the distance (L) between the adjacent light sources (2) and the distance (d) between the light diffuser plate (3) and the light sources (2). Uniformity of luminance may be improved further over the surface by setting the distance (d) between the light diffuser plate (3) and the light sources (2) smaller, depending on the value of the vertex angle (α) of the triangular ridges (7).

Also in embodiment A, since the entire surface on the back surface (3a) of the light diffuser plate (3) is formed as the matted surface (6), it is made possible to improve the efficiency of manufacturing and it becomes easier to switch the product to be manufactured to a different size.

According to the present invention, while the matted surface (6) is formed in at least a part of the back surface (3a) of the light diffuser plate (3) that makes contact with the front surface (31a) of the frame, it is necessary that the matted surface (6) has an arithmetic mean surface roughness Ra in a range from 0.8 to 15 μm and a mean surface irregularity interval Rsm in a range from 100 to 300 μm. When Ra is less than 0.8 μm or Rsm is larger than 300 μm, sufficient effect of suppressing annoying noise cannot be obtained. A matted surface having a Ra larger than 15 μm or a Rsm was less than 100 μm is difficult to manufacture, thus resulting in lower productivity. It is particularly preferable that the matted surface (6) has an arithmetic mean surface roughness Ra in a range from 1.0 to 10 μm and a mean surface irregularity interval Rsm in a range from 130 to 250 μm.

The cross section of the matted surface (6) may have, for example, substantially semicircular shape or a flattened shape with a curved boundary, although the present invention is not limited to such a cross section. The cross section of the matted surface (6) may have any shape as long as the conditions of Ra being in a range from 0.8 to 15 μm and Rsm being in a range from 100 to 300 μm are satisfied.

There is no restriction on the method of forming the matted surface (6). For example, the matted surface may be formed by transferring the matted surface pattern by means of an emboss roll, or by including fine particles in the resin to form the surface so that the particles protrude and form the matted surface, while the present invention is by no means restricted to these methods.

According to the present invention, while it is preferable to form a plurality of triangular ridges (7) having triangular cross section to protrude on the front surface (3b) of the light diffuser plate (3), it is necessary to set the vertex angle (α) of the triangular ridges (7) in a range from 40 to 150 degrees, and set the pitch (P) between adjacent triangular ridges (7) in a range from 10 to 500 μm. By setting the parameters within these ranges, luminance of emitted light can be sufficiently increased. A surface configuration having a vertex angle (α) less than 40 degrees is difficult to form with a high accuracy, and a surface configuration having a vertex angle (α) larger than 150 degrees has lower efficiency of collecting light. A surface configuration having the pitch (P) less than 10 μm is difficult to form with a high accuracy, and a surface configuration having a pitch (P) larger than 500 μm tends to have a problem of showing visible streaks of the triangular ridges (7). It is particularly preferable to set the vertex angle (α) of the triangular ridges (7) in a range from 60 to 120 degrees and set the pitch (P) in a range from 30 to 100 μm.

It is preferable to set the height (h) of the triangular ridges (7) in a range from 1.0 to 800 μm. A height larger than 1.0 μm enables the effect of increasing the luminance to be fully achieved, and a height not larger than 800 μm eliminates the problem of the visible streaks of the triangular ridges (7).

While there is no restriction on the method of forming the triangular ridges (7), for example, thermal transfer by means of a mold, an injection molding process, a machining process, an extrusion molding process or a molten extrusion molding process by means of an emboss roll may be employed.

The substantially V-shaped cross section between the adjacent triangular ridges (7) may be arc-shaped with a radius of curvature of about 5 μm. The apex of the triangular ridges (7) may also be arc-shaped, as long as the effects of the present invention are not compromised. Alternatively, the apex of the triangular ridges (7) may be flat, provided that it has a length of about one tenth of the pitch (P).

In embodiment A, the triangular ridges (7) of the light diffuser plate (3) comprise the ridges of prism shape (8) extending in one direction parallel to the surface thereof (one dimensional type) (refer to FIG. 2). However, the present invention is not limited to this constitution, and the triangular ridges (7) of the light diffuser plate may also comprise the ridges of prism shape (8) extending in two different directions (for example, two directions perpendicular to each other) parallel to the surface thereof (two dimensional type).

Also in embodiment A, the cross section of the triangular ridges (7) has the shape of an isosceles triangle that has two equal sides which form the vertex angle (α), as shown in FIG. 3. However, the present invention is not limited to this constitution, and the cross section may have the shape of a non-isosceles triangle as long as the triangle satisfies the condition that the vertex angle (α) is in a range from 40 to 150 degrees.

Also in embodiment A, all of the triangular ridges (7) are formed in the same shape of the same size. However, the present invention is not limited to this constitution, and such a constitution may be employed as at least one of the vertex angle (α) of the triangular ridges (7), the height (h) of the triangular ridges (7) and the pitch (P) of the triangular ridges (7) has varied values. For example, the constitution shown in FIG. 5 may be employed.

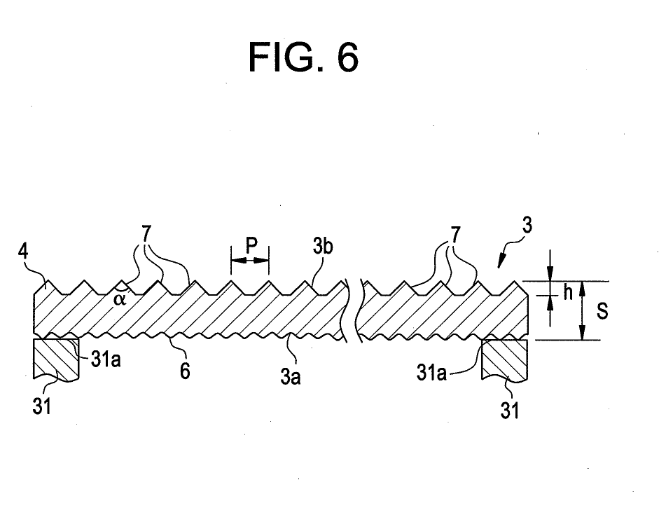

Also in embodiment A, although the adjacent triangular ridges (7) are disposed to be consecutive to each other, the present invention is not limited to this constitution as long as the effect of the present invention is not adversely affected. For example, there may be a flat surface disposed between the adjacent triangular ridges (7) as shown in FIG. 6.

The rugged surface section (4) may be constituted from triangular ridges other than the triangular ridges (7) that have a vertex angle (α) in a range from 40 to 150 degrees, as long as the effect of the present invention is not adversely affected. Similarly, the rugged surface section (4) may be constituted from triangular ridges other than the triangular ridges (7) that have a pitch (P) between adjacent triangular ridges (7) in a range from 10 to 500 μm, as long as the effect of the present invention is not adversely affected.

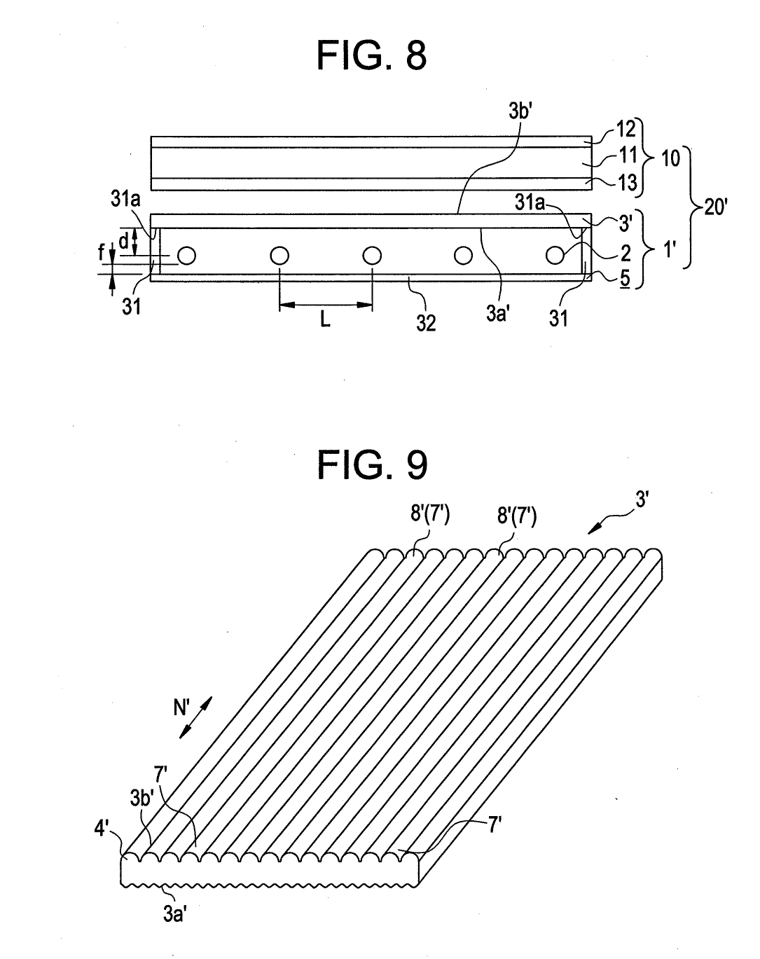

Another embodiment (embodiment B) of the liquid crystal display apparatus according to the present invention is shown in FIG. 8. In FIG. 8, reference numeral (1′) denotes a surface emission light source apparatus (backlight), (10) denotes the liquid crystal display panel and (20′) denotes a liquid crystal display apparatus. The liquid crystal display panel (10) comprises the liquid crystal cell (11) and the polarizer plates (12), (13) disposed on top and bottom sides of the liquid crystal cell (11).

The surface emission light source apparatus (1′) is disposed on the lower surface side (back surface side) of the bottom side polarizer plate (13) of the liquid crystal panel (10). The surface emission light source apparatus (1′) comprises a lamp box (5) of a low-profile box configuration having a rectangular shape in plan view that is open on the front surface side (top surface side), the plurality of linear light sources (2) disposed at a distance from each other in the lamp box (5), and a light diffuser plate (3′) made of a resin disposed on the front surface side (upside) of the plurality of linear light sources (2). The lamp box (5) has such a constitution as the frame (31) comprising a side plate extends from the periphery of the back plate (32) of rectangular shape in plan view toward the front side, and has an aperture on the front side as shown in FIG. 8. The light diffuser plate (3′) is secured onto the lamp box (5) so as to close the opening on the front surface side of the lamp box. That is, the light diffuser plate (3′) is fastened onto the lamp box (5) in such a state as the peripheral portion of the back surface (3a′) of the light diffuser plate (3′) makes contact with the front surface (31a) of a frame (31) of the lamp box (5). The lamp box (5) is lined with a reflector layer (not shown) on the inside thereof.

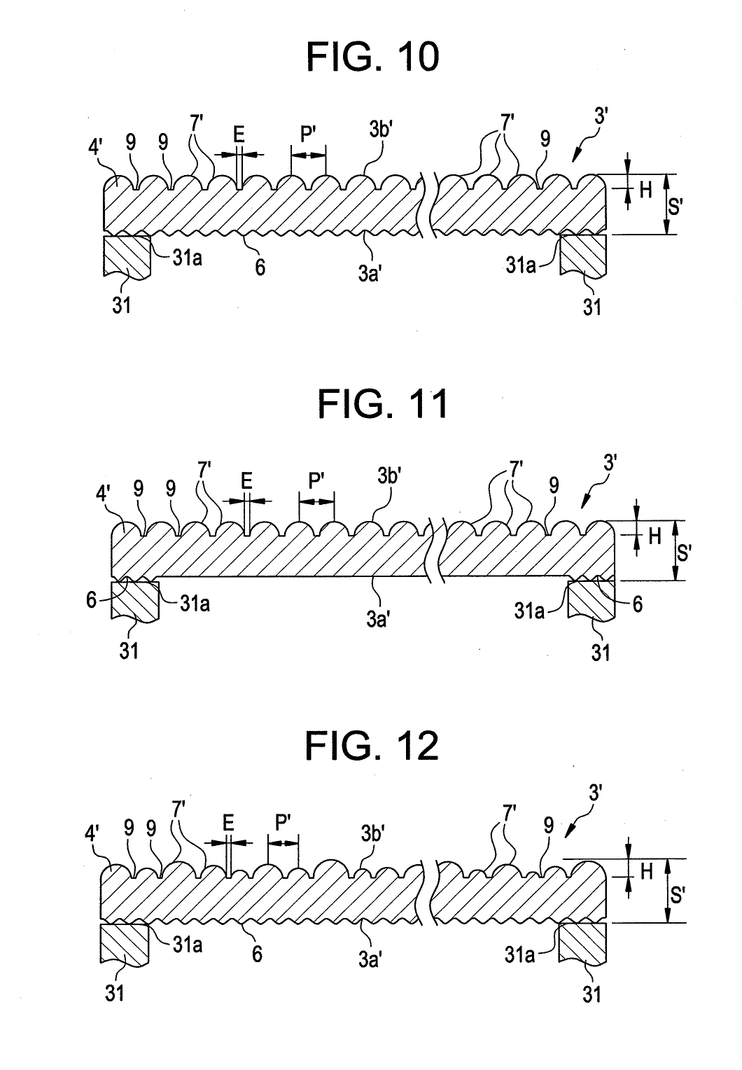

The light diffuser plate (3′) consists of a light transmitting plate made of a resin with the entire surface on the back surface (3a′) thereof being formed as the matted surface (6) as shown in FIG. 10. That is, the light diffuser plate (3′) is disposed so that the surface (3a′) of the light diffuser plate (3′) formed as the matted surface (6) is disposed on the side of the light source (2) (refer to FIG. 8). The matted surface (6) has an arithmetic mean surface roughness Ra in a range from 0.8 to 15 μm and a mean surface irregularity interval Rsm in a range from 100 to 300 μm. While the entire surface on the back surface (3a′) of the light diffuser plate (3′) is formed as the matted surface (6) in embodiment B, the present invention is not limited to this constitution. It suffices that at least a part of the back surface (3a′) of the light diffuser plate (3′) that makes contact with the front surface (31a) of the frame is formed as the matted surface (6). For example, such a constitution may be employed as only the part of the back surface (3a′) of the light diffuser plate (3′) that makes contact with the front surface (31a) of the frame is formed as the matted surface (6), as shown in FIG. 11.

A rugged surface section (4′) comprising a plurality of substantially semicircular ridges (7′) having substantially semicircular cross section is formed to protrude on the front surface (3b′) of the light diffuser plate (3′). That is, the surface (3b′) of the light diffuser plate (3′) whereon the substantially semicircular ridges (7′) are formed is disposed on the side of the liquid crystal display panel (10) (refer to FIG. 8). The pitch (P′) between adjacent substantially semicircular ridges is set in a range from 10 to 500 μm, the height (H) of the substantially semicircular ridges is set in a range from 30 to 500 μm, and the ratio H/P′ of height (H) to the pitch (P′) is set in a range from 0.2 to 0.8.

In embodiment B, the substantially semicircular ridges (7′ are constituted from ridges of cylindrical lens shape (ridges of substantially semi-cylindrical shape) (8′) formed to extend in one direction parallel to the surface of the light diffuser plate (3′), and the plurality of ridges of cylindrical lens shape (8′ are disposed substantially parallel to each other in the longitudinal direction (axial direction) thereof (refer to FIG. 9). The term “cylindrical lens shape” means the shape of one half of a substantially cylindrical body divided by a plane (that may or may not include the axial direction) parallel to the direction of centerline (longitudinal direction).

In embodiment B, the ridges of cylindrical lens shape (8′ are constituted from ridges of substantially semi-cylindrical shape, namely ridges having the shape of one half (semi-cylinder) of a substantially cylindrical body equally divided by a plane that includes the axial direction.

In embodiment B, linear light sources are used as the light sources (2), and the linear light sources (2) are disposed so that the longitudinal direction thereof substantially agrees with the longitudinal direction of the ridges of cylindrical lens shape (8′) of the light diffuser plate (3′). The ridges of cylindrical lens shape (8′) are disposed so that the longitudinal direction thereof substantially agrees with the longitudinal direction (N′) of the light diffuser plate (3′) (refer to FIG. 9).

In the surface emission light source apparatus (1′) having the constitution described above, at least a part of the back surface (3a′) of the light diffuser plate (3′) that makes contact with the front surface (31a) of the frame of the lamp box (5) is formed as the matted surface (6), while the matted surface (6) has an arithmetic mean surface roughness Ra in a range from 0.8 to 15 μm and a mean surface irregularity interval Rsm in a range from 100 to 300 μm. Therefore, the front surface (31a) of the frame of the lamp box (5) and the light diffuser plate (3′) are put into point contact or near point contact so as to reduce the friction therebetween, thereby preventing the generation of annoying noise when the front surface (31a) of the frame of the lamp box (5) and the light diffuser plate (3′) rub against each other.

Also because the pitch (P′) between adjacent substantially semicircular ridges (7′) is set in a range from 10 to 500 μm, the height (H) of the substantially semicircular ridges (7′) is set in a range from 3 to 500 μm, and the ratio (H/P) of height to pitch is set in a range from 0.2 to 0.8, luminance of emitted light can be sufficiently increased.

Additionally in embodiment B, due to the synergistic effect of forming the entire surface on the back surface (3a′) of the light diffuser plate (3′) as the matted surface (6) having an arithmetic mean surface roughness Ra in a range from 0.8 to 15 μm and a mean surface irregularity interval Rsm in a range from 100 to 300 μm, and forming the substantially semicircular ridges (7′) to protrude on the front surface (3b′) of the light diffuser plate (3′), light can be emitted uniformly without unevenness in luminance. That is, high uniformity of luminance can be achieved over the surface.

Also in embodiment B, the constitution of forming the entire surface on the back surface (3a′) of the light diffuser plate (3′ as the matted surface (6) makes it possible to improve the efficiency of manufacturing and makes it easier to switch the product to be manufactured to a different size.

According to the present invention, while the matted surface (6) is formed in at least a part of the back surface (3a′ of the light diffuser plate (3′) that makes contact with the front surface (31a) of the frame, it is necessary that the matted surface (6) has an arithmetic mean surface roughness Ra in a range from 0.8 to 15 μm and a mean surface irregularity interval Rsm in a range from 100 to 300 μm. When Ra is less than 0.8 μm or Rsm is larger than 300 μm, sufficient effect of suppressing annoying noise cannot be obtained. A matted surface having a Ra larger than 15 μm or a Rsm less than 100 μm is difficult to manufacture, thus resulting in lower productivity. It is particularly preferable that the matted surface (6) has an arithmetic mean surface roughness Ra in a range from 1.0 to 10 μm and a mean surface irregularity interval Rsm in a range from 130 to 250 μm.

The cross section of the matted surface (6) may have, for example, a substantially semicircular shape or a flattened shape with a curved boundary, although the present invention is not limited to such a cross section. The cross section of the matted surface (6) may have any shape as long as the conditions of Ra being in a range from 0.8 to 15 μm and Rsm being in a range from 100 to 300 μm are satisfied.

There is no restriction on the method of forming the matted surface (6). For example, the matted surface may be formed by transferring the matted surface pattern by means of an emboss roll, or by including fine particles in the resin to form the surface so that the particles protrude and form the matted surface.

Also according to the present invention, while the plurality of substantially semicircular ridges (7′) having substantially semi-cylindrical cross section are formed to protrude on the front surface (3b′) of the light diffuser plate (3′), it is necessary to set the pitch (P′) between adjacent substantially semicircular ridges (7′) in a range from 10 to 500 μm, set the height (H) of the substantially semicircular ridges (7′) in a range from 3 to 500 μm, and set the ratio (H/P) of height to pitch in a range from 0.2 to 0.8. By setting the parameters within these ranges, luminance of emitted light can be sufficiently increased. A surface configuration having a pitch (P′) less than 10 μm is difficult to form with high accuracy of configuration, and a surface configuration having a pitch (P′) larger than 500 μm tends to have a problem of showing visible streaks of the semicircular ridges (7′). When the height (H) is less than 3 μm, it becomes difficult to form the desired shape as the configuration of the protrusions (7′) melt down by the heat when the substantially semicircular ridges (7′) are formed on the light diffuser plate, and a height (H) larger than 500 μm leads to lower accuracy of shape formed by transferring the pattern of the substantially semicircular ridges (7′) onto the light diffuser plate. A surface configuration having a ratio (H/P) of height to pitch less than 0.2 does not have sufficient effect of suppressing the unevenness in luminance, and a surface configuration having the ratio (H/P) of height to pitch more than 0.8 is difficult to form with high accuracy. It is particularly preferable to set the pitch (P′) between adjacent semicircular ridges (7′) in a range from 50 to 300 μm, set the height (H) of the substantially semicircular ridges (7′) in a range from 25 to 250 μm, and set the ratio (H/P) of height to pitch in a range from 0.2 to 0.75.

While there is no restriction on the method of forming the substantially semicircular ridges (7′), for example, thermal transfer by means of a mold, an injection molding process, a machining process, an extrusion molding process or a molten extrusion transfer molding process by means of an emboss roll may be employed.

In embodiment B, the substantially semicircular ridges (7′) of the light diffuser plate (3′) comprise the ridges of cylindrical lens shape (8′) that extend in one direction parallel to the surface thereof (one dimensional type) (refer to FIG. 9). However, the present invention is not limited to this constitution, and the substantially semicircular ridges (7′) of the light diffuser plate (3′) may also comprise the ridges of cylindrical lens shape (8′) that extend in two different directions (for example, two directions perpendicular to each other) parallel to the surface thereof (two dimensional type).

Also in embodiment B, although the substantially semicircular ridges (7′) comprise the ridges of cylindrical lens shape (ridges of substantially semi-cylindrical shape) (8′) (refer to FIG. 9), the present invention is not limited to this constitution. For example, such a constitution may be employed as a number of substantially semicircular ridges (7′), which are not continuous in the longitudinal direction (N′), are disposed separate from each other in the longitudinal direction (N′).

Also in embodiment B, the substantially semicircular ridges (7′) are formed with semicircular cross section, although the present invention is not limited to this constitution. For example, the semicircular ridges (7′) may have the shape of one half of a cylindrical body divided by a plane that does not include the centerline thereof, or may be formed in a semi-elliptical cross section or a cross section having flattened shaped with a curved boundary, as shown in FIG. 14. The term substantially semicircular ridges is used to include protrusions of such shapes.

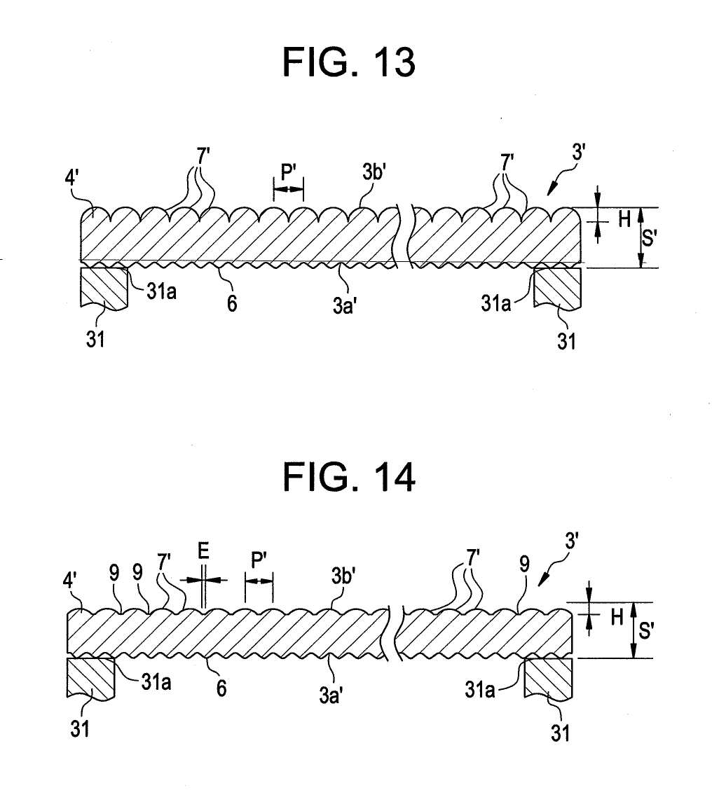

While embodiment B has such a constitution that has the flat surface (9) between adjacent semicircular ridges (7′), the present invention is not limited to this constitution. For example, such a constitution may be employed as the semicircular ridges (7′) are formed consecutively without a flat surface formed therebetween as shown in FIG. 13. In the case when the constitution where the semicircular ridges (7′) are formed consecutively without flat surface formed therebetween is employed, the substantially V-shaped cross section between the adjacent semicircular ridges (7′) may be arc-shaped with a radius of curvature of about 5 μm, as long as the effect of suppressing the unevenness in luminance is not compromised. In the case when the constitution that has the flat surface (9) formed between adjacent semicircular ridges (7′) is employed, it is preferable to set the width of the groove (E) of the flat surface (9) so that the value of E/P′ is less than 0.1.

Also in the embodiment described above, although the substantially semicircular ridges (7′) are formed with a cross section that is symmetrical with respect to the normal line (vertical line perpendicular to horizontal) that passes the center of the circle as shown in FIG. 10, the present invention is not limited to this constitution. For example, an asymmetrical cross section may also be employed such as the arc on the left side swells more to the front than the arc on the right side, or the arc on the right side swells more to the front than the arc on the left side, as long as the value of the ratio E/P′ is in a range from 0.1 to 0.8.

Also in the embodiment described above, all of the substantially semicircular ridges (7′) are formed in the same shape of the same size. However, the present invention is not limited to this constitution, and such a constitution may be employed as at least one of the pitch (P′) between the adjacent substantially semicircular ridges (7′), the height (H) of the substantially semicircular ridges (7′) and the ratio (H/P) of height to pitch has varied values. For example, the constitution shown in FIG. 12 may be employed.

The rugged surface section (4′) may also be constituted from substantially semicircular ridges other than the substantially semicircular ridges (7′) where the pitch (P′) is set in a range from 10 to 500 μm, the height (H) is set in a range from 3 to 500 μm, and the ratio (H/P) of height to pitch is set in a range from 0.2 to 0.8, as long as the effects of the present invention are not compromised.

While there is no restriction on the values of the thickness (S) of the light diffuser plate (3) and the thickness (S′) of the light diffuser plate (3′), it is preferable to set the thickness in a range from 1.0 to 5.0 mm.

It is preferable to set the total light transmittance of the light diffuser plate (3) or (3′) in a range from 55 to 85%, and more preferably from 55 to 75%. Within this range, it is made possible to obtain a sufficient level of luminance and achieve sufficient effect of suppressing the unevenness in luminance by the synergistic effect described previously. There is no restriction on the total light transmittance which can be controlled by adding, for example, a light diffusing agent. The total light transmittance is measured according to JIS K7361-1 (1997). In embodiment B, the total light transmittance is measured by disposing the front surface (3b′) of the light diffuser plate (3′) where ridges of substantially semicircular shape (7′) are formed to face an integrating sphere and scanning across the pitch in the right to left direction.

According to the present invention, while there is no restriction on the light diffuser plate (3) or (3′), a plate consisting of a single layer of a translucent resin or a multi-layer plate consisting of a base layer of a translucent resin and one or more layers made of a different kind of translucent resin stacked on at least one surface thereof may be used.

As the translucent resin, for example, acrylic resin, styrene resin, polycarbonate resin, polyethylene, polypropylene, cyclic polyolefin, cyclic olefin copolymer, polyethylene terephthalate, MS resin (methyl methacrylate-styrene copolymer), ABS resin (acrylonitryl-butadiene-styrene copolymer resin), AS resin (acrylonitryl-styrene copolymer) or the like may be used.

The light diffuser plates (3) and (3′) include a light diffusing agent (light diffusing particles) added thereto as required. There is no restriction on the material used as the light diffusing agent, as long as it consists of particles having a refractive index different from that of the translucent resin used to form the light diffuser plates (3) and (3′). As an inorganic light diffusing agent, while there is no restriction, such materials as calcium carbonate, barium sulfide, titanium oxide, aluminum hydroxide, silica, glass, talc, mica, white carbon, magnesium oxide, zinc oxide or the like may be used. These materials may be surface-treated with a fatty acid or the like. As an organic light diffusing agent, while there is no restriction, such materials as particles of copolymerized styrene, particles of copolymerized acryl, particles of copolymerized siloxane and the like may be used. It is particularly preferable to use high polymer particles having a mean molecular weight of 500,000 to 5,000,000 or linked polymer particles having a ratio of gellation not lower than 10% by mass when dissolved in acetone. For the light diffusing agent, one of those described above or a mixture of two or more thereof may be used.

The absolute value of difference in refractive index between the translucent resin and the light diffusing agent is preferably 0.02 or more in view of the light diffusing property, and not more than 0.13 in view of light transmittance. Thus, the absolute value of difference in refractive index between the translucent resin and the light diffusing agent is preferably in a range from 0.02 to 0.13.

The light diffuser plates (3) and (3′) may include additives such as an ultraviolet ray absorbing agent, a thermal stabilization agent, an anti-oxidization agent, a weathering agent, a light stabilizer, a fluorescent whitener or a processing stabilizer agent added thereto. When an ultraviolet ray absorbing agent is added, it is preferable to add 0.1 to 3% parts by mass of the ultraviolet ray absorbing agent to 100 parts by mass of the translucent resin. Within this range, the ultraviolet ray absorbing agent can be suppressed from bleeding onto the surface so as to maintain the appearance in good condition. When a thermal stabilization agent is also added, it is preferable to add not more than 2 parts by mass of the thermal stabilization agent for 1 part by mass of the ultraviolet ray absorbing agent included in the translucent resin, and it is more preferable to add 0.01 parts by mass to 1 part by mass of the thermal stabilization agent for 1 part by mass of the ultraviolet ray absorbing agent included in the translucent resin.

While there is no restriction on the light sources (2), a point light source such as a light emitting diode may be used as well as a linear light source such as a fluorescent lamp, a halogen lamp or a tungsten lamp may be used.

The distance (L) between adjacent light sources (2), (2) is set preferably not less than 10 mm in order to decrease power consumption. The distance (d) between the light sources (2) and the light diffuser plate (3) or (3′) is set preferably not more than 50 mm in order to reduce the depth of the liquid crystal display apparatus. The ratio d:L is preferably in a range from 1:5 to 5:1. It is more preferable to set the distance (L) between adjacent light sources (2), (2) in a range from 10 to 100 mm and the distance (d) between the light sources (2) and the light diffuser plate (3) or (3′) in a range from 10 to 50 mm.

The light diffuser plate (3) or (3′), the surface emission light source apparatus (1) or (1′) and the liquid crystal display apparatus (20) or (20′) of the present invention are not limited to those of the embodiments A and B described above, and any modifications within the scope of the claims may be made without deviating from the spirit of the invention.

### EXAMPLES

Examples of the present invention will now be described, although it is understood that the present invention is not limited to these Examples.

### Raw Materials

Translucent resin A: Styrene resin (“HRM40” manufactured by Toyo Styrene Co., Ltd., refractive index 1.59)

Translucent resin B: MS resin (“MS200NT” manufactured by Nippon Steel Chemical Co., Ltd., refractive index 1.57, styrene/methyl methacrylate=80 parts by mass/20 parts by mass)

Light diffusing agent A: Linked PMMA particles (“Sumipex XC1A” manufactured by Sumitomo Chemical Co., Ltd., refractive index 1.49, mean particle size by weight average of 35 μm)

Light diffusing agent B: Linked siloxane polymer particles (“Torayfil DY33-719” manufactured by Toray Dow Corning Inc., refractive index 1.42, mean particle size by volumetric average of 2 μm)

Light diffusing agent C: “KE-P50” manufactured by Nippon Shokubai Co., Ltd. (refractive index 1.43, mean particle size of 0.54 μm)

Light diffusing agent D: “Tospal 120” manufactured by Momentive Performance Materials Japan (refractive index 1.49, mean particle size by volumetric average of 2 μm)

Light diffusing agent master batch A: 52.0 parts by mass of the translucent resin A, 40.0 parts by mass of the light diffusing agent A, 4.0 parts by mass of the light diffusing agent B, 2.0 parts by mass of Sumisoap 200 (ultraviolet ray absorbing agent manufactured by Sumitomo Chemical Co., Ltd.) and 2.0 parts by mass of Sumiriser GP (thermal stabilization agent manufactured by Sumitomo Chemical Co., Ltd.) were mixed in a dry process. The mixture was charged into the hopper of a 65 mm biaxial extrusion machine so as to melt and mix in a cylinder and was extruded in the form of a strand, that was formed into pellets as the light diffusing agent master batch A. The extrusion process was carried out by setting the cylinder temperature to gradually become higher toward downstream from 200° C. at a position below the hopper to 250° C. near the extrusion die.

Light diffusing agent master batch B: 75.8 parts by mass of the translucent resin B, 23.0 parts by mass of the light diffusing agent A, 1.0 part by mass of LA-31 (ultraviolet ray absorbing agent manufactured by ADEKA Corporation) and 0.2 parts by mass of Sumiriser GP (thermal stabilization agent manufactured by Sumitomo Chemical Co., Ltd.) were mixed in a dry process. The mixture was charged into the hopper of a 65 mm biaxial extrusion machine so as to melt and mix in a cylinder and was extruded in the form of strand, that was formed into pellets as the light diffusing agent master batch B. The extrusion process was carried out by setting the cylinder temperature to gradually become higher toward the downstream from at a point 200° C. at a point below the hopper to 250° C. near the extrusion die.

Light diffusing agent master batch C: 86.0 parts by mass of the translucent resin B, 10.0 parts by mass of the light diffusing agent D, 2.0 parts by mass of Sumisoap 200 (ultraviolet ray absorbing agent manufactured by Sumitomo Chemical Co., Ltd.) and 2.0 parts by mass of Sumiriser GP (thermal stabilization agent manufactured by Sumitomo Chemical Co., Ltd.) were mixed in a dry process. The mixture was charged into the hopper of a 65 mm biaxial extrusion machine so as to melt and mix in a cylinder and was extruded in the form of a strand, that was formed into pellets as the light diffusing agent master batch C. The extrusion process was carried out by setting the cylinder temperature to gradually become higher toward the downstream from 200° C. at a point below the hopper to 250° C. near the extrusion die.

### Example A1

97.0 parts by mass of the translucent resin A and 3.0 parts by mass of the light diffusing agent master batch A were mixed in a dry process, and the mixture was melted and mixed in a first extrusion machine of which the cylinder temperature was set in a range from 190 to 250° C., and was supplied to a feed block. Meanwhile the light diffusing agent master batch B was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form an intermediate layer (base layer) and the resin supplied from the second extrusion machine to the feed block would form surface layers. These layers were pressed together and cooled by polishing rolls, so as to make a light diffuser plate (3) constituted from three layers (intermediate layer 1.9 mm in thickness and two surface layers each 0.05 mm in thickness) measuring 23.0 cm in width and 2.0 mm in thickness.

The gap between the intermediate roll and the lower roll, among the three polishing rolls, during the molding process is set larger than the thickness of the light diffuser plate, 2.0 mm, so as to allow the light diffusing particles added to the resin to protrude on the surface without being smoothed out, thus resulting in the matted surface (6) all over one surface (back surface) of the light diffuser plate (3). The arithmetic mean surface roughness Ra of the matted surface (6) was 1.24 μm and the mean surface irregularity interval Rsm of the matted surface (6) was 169.0 μm. The other surface (front surface) (3b) of the light diffuser plate (3) was formed as a smooth surface.

### Example A2

97.0 parts by mass of the translucent resin A and 4.5 parts by mass of the light diffusing agent master batch A were mixed in a dry process, and the mixture was melted and mixed in a first extrusion machine of which the cylinder temperature was set in a range from 190 to 250° C., and was supplied to the feed block. Meanwhile the light diffusing agent master batch B was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form an intermediate layer (base layer) and the resin supplied from the second extrusion machine to the feed block would form surface layers. These layers were pressed together and cooled by polishing rolls, so as to make a light diffuser plate (3) constituted from three layers (intermediate layer 1.4 mm in thickness and two surface layers each 0.05 mm in thickness) measuring 23.0 cm in width and 1.5 mm in thickness.

The gap between the intermediate roll and the lower roll, among the three polishing rolls, during the molding process is set larger than the thickness of the light diffuser plate, 1.5 mm, so as to allow the light diffusing particles added to the resin to protrude on the surface without being smoothed out, thus resulting in the matted surface (6) all over one surface (back surface) of the light diffuser plate (3) (refer to FIG. 3). The arithmetic mean surface roughness Ra of the matted surface (6) was 4.19 μm and the mean surface irregularity interval Rsm of the matted surface (6) was 195.0 μm.

The intermediate roll, among the three polishing rolls, was wrapped with a sheet having protrusions formed on the surface fastened on the circumferential surface thereof. Thus a number of ridges (8) constituted from the triangular ridges (7) were formed over the entire surface of the other surface (front surface) (3b) of the light diffuser plate (3) (refer to FIGS. 2 and 3). The vertex angle (α) of the triangular ridges (7) was 90.0 degrees, and the pitch (P) between adjacent triangular ridges was 50.0 μm.

### Example A3

Over the entire surface of the front surface (smooth surface) of the light diffuser plate obtained in Example 1, numerous ridges (8) constituted from the triangular ridges (7) were formed by using a thermal press (Shindo model ASF hydraulic press manufactured by Shinto Metal Industries, Ltd.) (refer to FIG. 3), thereby making a light diffuser plate (3) having a thickness of 2.0 mm. In the thermal pressing operation, the light diffuser plate obtained in Example 1 was placed with the front surface (smooth surface) facing upward on the thermal press and placing a prism film with the prisms facing downward on the front surface (smooth surface), and pressure was applied for about 3 minutes with the temperature of the thermal press being set to 160° C. on the upper surface side and 70° C. on the lower surface side. While the triangular ridges (7) were formed on the front surface (3b) by the thermal press, the matted surface (6) on the back surface (3a) was maintained. The vertex angle (α) of the triangular ridges (7) was 90.0 degrees, and the pitch (P) between adjacent triangular ridges was 50.0 μm.

### Example A4

99.7 parts by mass of the translucent resin A and 0.3 parts by mass of the light diffusing agent C were mixed in a dry process, and the mixture was melted and mixed in an extrusion machine of which the cylinder temperature was set in a range from 190 to 250° C., and was supplied to a feed block. The resin supplied from the first extrusion machine to the feed block was subjected to a single-layer extrusion molding process with a multi-manifold die at an extrusion temperature of 250° C., and was pressed and cooled by polishing rolls, thereby making a resin plate (smooth on both surfaces) measuring 23.0 cm in width and 2.0 mm in thickness.

Then matted surface was formed on one surface of the resin plate by using a thermal press (Shindo model ASF hydraulic press manufactured by Shinto Metal Industries, Ltd.). In the thermal pressing operation, a copper plate (having a matted surface of Ra=6.0 μm and Rsm=111.0 μm formed by sandblasting) was placed with the matted surface facing upward below the resin plate on the thermal press, so as to apply a pressure for about 3 minutes with the temperature of the thermal press being set to 70° C. on the upper surface side and 170° C. on the lower surface side. By the thermal pressing operation, the light diffuser plate (3) having the matted surface formed all over one surface (back surface) thereof was made. The matted surface (6) had an arithmetic mean surface roughness Ra of 5.75 μm and a mean surface irregularity interval Rsm of 163.0 μm. The other surface (front surface) (3b) of the light diffuser plate (3) was smooth.

### Example A5

99.7 parts by mass of the translucent resin A and 0.3 parts by mass of the light diffusing agent C were mixed in a dry process, and the mixture was melted and mixed in an extrusion machine of which the cylinder temperature was set in a range from 190 to 250° C., and was supplied to a feed block. The resin supplied from the first extrusion machine to the feed block was subjected to a single-layer extrusion molding process with a multi-manifold die at an extrusion temperature of 250° C., and was pressed and cooled by polishing rolls, thereby making a resin plate (smooth on both surfaces) measuring 23.0 cm in width and 2.0 mm in thickness.

Then a matted surface was formed on one surface (back surface) of the resin plate and numerous ridges (8) constituted from the triangular ridges (7) were formed to protrude on the other surface (front surface) by using a thermal press (Shindo model ASF hydraulic press manufactured by Shinto Metal Industries, Ltd.). In the thermal pressing operation, a prism film was placed on the resin plate with the prisms facing downward and a copper plate (having a matted surface of Ra=3.15 μm and Rsm=170.0 μm formed by sandblasting) was placed with the matted surface facing upward below the resin plate on the thermal press, so as to apply a pressure for about 3 minutes with the temperature of the thermal press being set to 160° C. on the upper surface and 170° C. on the lower surface. By the thermal pressing operation, a light diffuser plate (3) having a matted surface formed all over one surface (back surface) thereof and numerous ridges (8) constituted from the triangular ridges (7) formed to protrude on the other surface (front surface) (3b) of the light diffuser plate (3) was made (refer to FIG. 3). The matted surface (6) had an arithmetic mean surface roughness Ra of 5.74 μm and a mean surface irregularity interval Rsm of 174.0 μm. The vertex angle (α) of the triangular ridges (7) was 90.0 degrees, and the pitch (P) between adjacent triangular ridges was 50.0 μm.

### Comparative Example A1

97.0 parts by mass of the translucent resin A and 3.0 parts by mass of the light diffusing agent master batch A were mixed in a dry process, and the mixture was melted and mixed in a first extrusion machine of which the cylinder temperature was set in a range from 190 to 250° C., and was supplied to the feed block. Meanwhile the translucent resin A was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form an intermediate layer (base layer) and the resin supplied from the second extrusion machine to the feed block would form surface layers. These layers were pressed together and cooled by polishing rolls, so as to make the light diffuser plate constituted from the three layers (intermediate layer 1.9 mm thick and two surface layers each 0.05 mm thick) measuring 23.0 cm in width and 2.0 mm in thickness.

The gap between the intermediate roll and the lower roll, among the three polishing rolls, during the molding process is set larger than the thickness of the light diffuser plate, 2.0 mm, although no light diffusing particles were added to the resin constituting the surface layer and therefore protrusions of the light diffusing particles were not formed, thus resulting in substantially smooth surfaces for both surfaces. Both surfaces of the light diffuser plate had an arithmetic mean surface roughness Ra of 0.21 μm and a mean surface irregularity interval Rsm of 0.56 μm.

### Comparative Example A2

99.7 parts by mass of the translucent resin A and 0.3 parts by mass of the light diffusing agent C were mixed in a dry process, and the mixture was melted and mixed in an extrusion machine of which the cylinder temperature was set in a range from 190 to 250° C., and was supplied to the feed block. The resin supplied from the extrusion machine to the feed block was subjected to a single-layer extrusion molding process with a multi-manifold die at an extrusion temperature of 250° C., and was pressed and cooled by polishing rolls, thereby making a light diffuser plate (smooth on both surfaces) measuring 23.0 cm in width and 2.0 mm in thickness.

The gap between the intermediate roll and the lower roll, among the three polishing rolls, during the molding process was set to 2.0 mm, and therefore protrusions of the light diffusing particles were not formed, thus resulting in substantially smooth surfaces for both surfaces. Both surfaces of the light diffuser plate had an arithmetic mean surface roughness Ra of 0.07 μm while the mean surface irregularity interval Rsm could not be measured (Rsm was less than the measurable limit of 0.04 μm).

### Comparative Example A3

Over the entire surface of one surface (substantially smooth surface) of the light diffuser plate obtained in Comparative Example 2, numerous ridges constituted from triangular ridges were formed by using a thermal press (Shindo model ASF hydraulic press manufactured by Shinto Metal Industries, Ltd.), thereby making a light diffuser plate having a thickness of 2.0 mm. In the thermal pressing operation, the light diffuser plate obtained in Comparative Example 2 was placed with one surface facing upward on the thermal press and placing a prism film thereon with the prisms facing downward, and pressure was applied for about 3 minutes with the temperature of the thermal press being set to 160° C. on the upper surface and 70° C. on the lower surface. While the triangular ridges were formed on one surface by the thermal press, the smooth surface on the other surface was maintained. The vertex angle (α) of the triangular ridges (7) was 90.0 degrees, and the pitch (P) between adjacent triangular ridges was 50.0 μm.

The light diffuser plates made as described above were evaluated according to the following methods. The results of evaluation are shown in Table A1.

TABLE A1

| | | | Properties of | | Total light | | | |
|---|---|---|---|---|---|---|---|---|
| | Properties of | | triangular ridges | | transmittance of | Diffusion rate | | Annoying noise |
| | matted surface | | Vertex angle | Pitch P | light diffuser | D of light | Uniformity of | suppressing |
| | Ra (μm) | Rsm (μm) | α (degrees) | (μm) | plate Tt (%) | diffuser plate (%) | luminance (%) | performance |
| Example 1 | A1.24 | A169.0 | — | — | A71.0 | A43.1 | A85.3 | A |
| Example 2 | A4.19 | A195.0 | A90.0 | A50.0 | A60.8 | A50.6 | A95.2 | A |
| Example 3 | A1.24 | A169.0 | A90.0 | A50.0 | A52.9 | A60.7 | A93.7 | A |
| Example 4 | A5.75 | A163.0 | | | A70.1 | A25.7 | A86.8 | A |
| Example 5 | A5.74 | A174.0 | A90.0 | A50.0 | A53.2 | A61.8 | A98.1 | A |
| Comparative | A0.21 | A0.56 | — | — | A69.0 | A44.7 | A90.4 | C |
| Example 1 | | | | | | | | |
| Comparative | A0.07 | Unable to | — | — | A68.7 | A28.5 | A81.5 | C |
| Example 2 | | measure | | | | | | |
| Comparative | A0.05 | Unable to | A90.0 | A50.0 | A51.9 | A26.3 | A86.8 | C |
| Example 3 | | measure | | | | | | |

### Measurement of Total Light Transmittance

Total light transmittance (%) of the light diffuser plate was measured by using a light transmittance meter (“HR-100” manufactured by Murakami Color Engineering Laboratory) in accordance to JIS K7361-1 (1997).

### Evaluation of Uniformity of Luminance

A lamp box made of polycarbonate (having a plurality of fluorescent tubes disposed with a space from each other therein) was prepared by removing a liquid crystal panel, various optical films and a light diffuser plate from a 20-inch liquid crystal television set available in the market. The light diffuser plate made in the process of the Examples or the Comparative Examples was secured onto the lamp box to make contact with the front face of the frame, so as to close the aperture of the lamp box. Then luminance of light emitted by the experimental setup with the light diffuser plate set thereon was measured with a luminance meter “Eye Scale-3WS” manufactured by I-System Co., Ltd. Uniformity of luminance (%) was calculated from the minimum value of luminance “C1” and the maximum value of luminance “C2” by the following equation.

Uniformity of luminance (%)=C1/C2×100

The luminance was measured as follows. A 20-inch liquid crystal television set was placed on the floor of a dark room where temperature and humidity were controlled so as to be constant (temperature 25.0° C., humidity 50.0%) with the front surface side facing upward (back surface on the floor). A camera was disposed above the liquid crystal television set facing downward so as to capture the entire front surface of the liquid crystal television set. The distance between the front surface of the liquid crystal television set and the camera was set to 65.0 cm, and the measuring conditions were set to a shutter speed of 1/500 seconds, a gain of 1 and an aperture of 16. Measurements were taken in a region of 60 mm by 60 mm around the center of the front surface of the liquid crystal television set, and uniformity of luminance (%) was calculated from the minimum value of luminance and the maximum value of luminance among the measured values.

The 20-inch liquid crystal television set obtained in the market, that was used in Examples A1 to A5 and Comparative Examples A1 to A3, had a distance (L) between the adjacent light sources of 28.0 mm, a diameter of the light source of 3.0 mm, a distance (d) between the light diffuser plate and the light sources of 11.0 mm and a distance (f) between the light source and the reflector (bottom surface of the lamp box) of 2.0 mm (refer to FIG. 1). Reflecting triangular ridges having triangular cross section were formed at the center of the space between adjacent light sources on the reflector (bottom surface of the lamp box), and the reflecting triangular ridges having triangular cross section extended along the longitudinal direction of the light source (longitudinal direction of the lamp box). The vertex angle (β) of the reflecting triangular ridges was 90.0 degrees, and the length (M) of the base side of the reflecting triangular ridges was 8.0 mm (refer to FIG. 1).

### Measurement of Diffusion Ratio D of Light Diffuser Plate

Diffusion ratio D (%) was determined by measuring the changes in the intensity distribution of the transmitted light with light incident on the light diffuser plate (made in the Examples or the Comparative Examples) at a specified angle, by using an automatic scanning photometer (“GP230” manufactured by Murakami Color Engineering Laboratory). The back surface of the light diffuser plate was directed toward the light source and the front surface of the light diffuser plate was directed toward an integrating sphere. Measurement was made by scanning across the pitch of the triangular ridges, in the case when the light diffuser plate had the triangular ridges formed on the front surface, by setting the diameter of the light beam to 1.7 mm, setting the intensity of the emitted light and sensitivity of receiving the light constant and setting the incident angle of light to 0 degrees.

### Evaluation of Annoying Noise Preventing Performance

A lamp box made of polycarbonate (having a plurality of fluorescent tubes disposed with a space from each other therein) was prepared by removing a liquid crystal panel, various optical films and a light diffuser plate from a 20-inch liquid crystal television set available in the market, the same as that used in the evaluation of uniformity of luminance). The light diffuser plate made in the process of the Examples or the Comparative Examples was secured onto the lamp box to make contact with the front face of the frame, so as to close the aperture of the lamp box. Then the liquid crystal panel was reset on the lamp box, so as to reconstruct the liquid crystal television set. The liquid crystal television set was held with both hands in the normal state of vertical posture, and was shaken back and forth with a frequency of about 180 times a minute, to see whether annoying noise was generated or not. A rating of “A” was given when annoying noise was not generated, “B” was given when slight annoying noise was generated, and “C” was given when conspicuous annoying noise was generated.

### Measurement of Arithmetic Mean Surface Roughness Ra

Arithmetic mean surface roughness Ra was measured in accordance to JIS B0601-2001. By using a surface roughness meter (“SJ-201P” manufactured by Mitsutoyo Corporation) that was set to a cutoff value of 2.5×5 and an automatic measuring range, the arithmetic mean surface roughness Ra of the matted surface of the light diffuser plate was measured.

### Measurement of Mean Surface Irregularity Interval Rsm

Mean surface irregularity interval Rsm was measured in accordance to JIS B0601-2001. By using a surface roughness meter (“SJ-201P” manufactured by Mitsutoyo Corporation) that was set to a cutoff value of 2.5×5 and an automatic measuring range, the mean surface irregularity interval Rsm of the matted surface of the light diffuser plate was measured.

As can be seen from the table, the surface emission light source apparatus and the liquid crystal display apparatus constituted by using the light diffuser plates of Examples A1 to A5 of the present invention were capable of suppressing the generation of annoying noise satisfactorily.

Those of Comparative Examples A1 to A3, that were out of the scope of the present invention, were unable to suppress the generation of annoying noise.

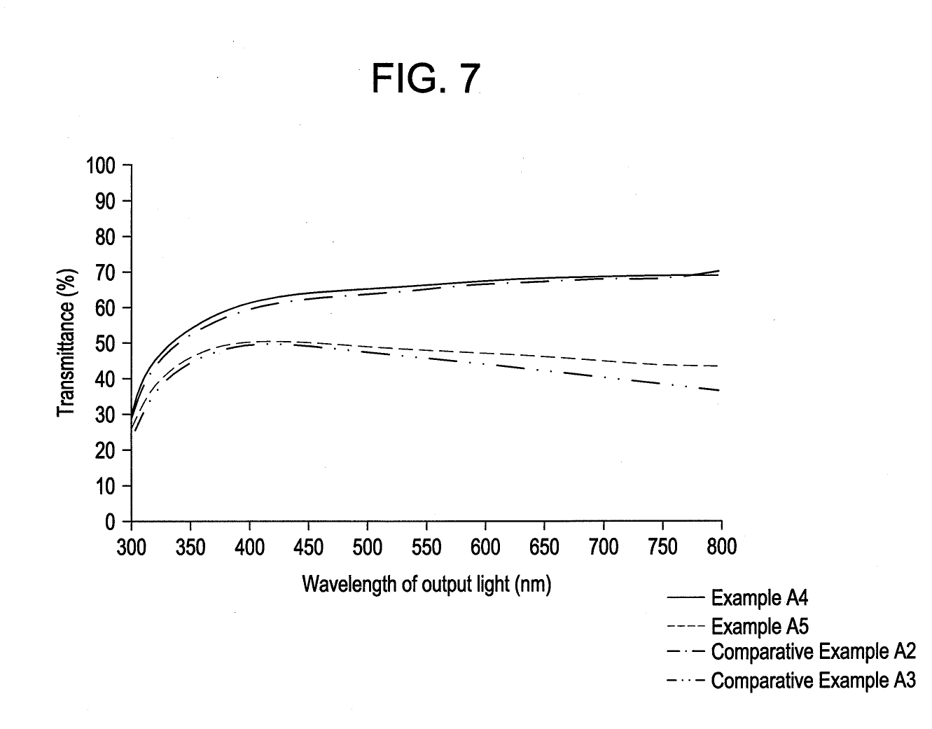

Then spectral transmittance was measured according to the following method of measuring spectral transmittance of the light diffuser plates made in Example A4, Example A5, Comparative Example A2 and Comparative Example A3. The results of the measurements are shown in FIG. 7.

### Method of Measuring Spectral Transmittance

Spectral transmittance was measured by using a recording spectrophotometer (“U-4000” manufactured by Hitachi Keisokuki), in the visible light region with the back surface of the light diffuser plate directed toward the light source and the front surface of the light diffuser plate directed toward an integrating sphere. Measurement was made by scanning across the pitch of the triangular ridges, in the case when the light diffuser plate had the triangular ridges formed on the front surface thereof.

Comparison of Example A4 and Comparative Example A2 shown in FIG. 7 shows that transmittance in the visible light region remains almost the same regardless of whether the matted surface is formed or not (formed in Example A4 and not formed in Comparative Example A2).

Comparison of Example A5 and Comparative Example A3 shown in FIG. 7, on the other hand, shows that transmittance in the visible light region is significantly improved by forming the matted surface in the case of the light diffuser plate having the triangular ridges formed thereon (Example A5). Comparative Example A3 where the matted surface was not formed showed low transmittance in the visible light region.

### Example B1

97.5 parts by mass of the translucent resin A and 2.5 parts by mass of the light diffusing agent master batch C were mixed in a dry process, and the mixture was melted and mixed in a first extrusion machine of which the cylinder temperature was set in a range from 190 to 250° C., and was supplied to the feed block. Meanwhile 67.8 parts by mass of the translucent resin B and 32.2 parts by mass of the light diffusing agent master batch B were mixed in a dry process, and the mixture was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form a base layer and the resin supplied from the second extrusion machine to the feed block would form a back surface layer (surface layer on the back surface side). These layers were pressed together and cooled by polishing rolls, so as to make the light diffuser plate (3′) constituted from the two layers (base layer 1.43 mm in thickness and back surface layer 0.07 mm in thickness) measuring 23.5 cm in width and 1.5 mm in thickness.

The gap between the intermediate roll and the lower roll, among the three polishing rolls, during the molding process is set larger than the thickness of the light diffuser plate, 1.5 mm, so as to allow the light diffusing particles added to the resin to protrude on the surface without being smoothed out, thus resulting in the matted surface (6) all over one surface (back surface) (3a′) of the light diffuser plate (3′). The arithmetic mean surface roughness Ra of the matted surface (6) was 1.10 μm and the mean surface irregularity interval Rsm of the matted surface (6) was 202 μm.

The intermediate roll, among the three polishing rolls, was wrapped with a sheet having grooves of semicircular cross section formed on the surface fastened on the circumferential surface thereof. Thus a number of semicircular ridges (7′) of semicircular cross section were formed over the entire surface of the base layer. That is, a number of ridges of cylindrical lens shape (8′) were formed over the entire surface of the other surface (front surface) (3b′) of the light diffuser plate (3′) (refer to FIGS. 9 and 10). The height (H) of the substantially semicircular ridges (7′) was 35.2 μm, the pitch (P′) between adjacent substantially semicircular ridges (7′) was 102.4 μm, and the ratio (H/P′) of height to pitch was 0.34.

### Example B2

97.5 parts by mass of the translucent resin A and 2.5 parts by mass of the light diffusing agent master batch C were mixed in a dry process, and the mixture was melted and mixed in a first extrusion machine of which the cylinder temperature was set in a range from 190 to 250° C., and was supplied to the feed block. Meanwhile 67.8 parts by mass of the translucent resin B and 32.2 parts by mass of the light diffusing agent master batch B were mixed in a dry process, and the mixture was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form a base layer and the resin supplied from the second extrusion machine to the feed block would form a back surface layer (surface on the back surface side). These layers were pressed together and cooled by polishing rolls, so as to make the light diffuser plate (3′) constituted from the two layers (base layer 1.42 mm in thickness and back surface layer 0.07 mm in thickness) measuring 22.8 cm in width and 1.49 mm in thickness.

The gap between the intermediate roll and the lower roll, among the three polishing rolls, during the molding process is set larger than the thickness of the light diffuser plate, 1.49 mm, so as to allow the light diffusing particles added to the resin to protrude on the surface without being smoothed out, thus resulting in the matted surface (6) formed all over the back surface. That is, the entire surface of one surface (back surface) (3a′) of the light diffuser plate (3′) was formed as a matted surface (6). The arithmetic mean surface roughness Ra of the matted surface (6) was 1.21 μm and the mean surface irregularity interval Rsm of the matted surface (6) was 210 μm.

The intermediate roll, among the three polishing rolls, has numerous grooves of semicircular cross section formed in the form of streaks on the circumferential surface thereof. Thus a number of semicircular ridges (7′) of semicircular cross section are formed over the entire surface of the base layer. That is, a number of ridges of cylindrical lens shape (8′) are formed over the entire surface of the other surface (front surface) (3b′) of the light diffuser plate (3′) (refer to FIGS. 9 and 10). The height (H) of the substantially semicircular ridges (7′) was 43.8 μm, the pitch (P′) between adjacent substantially semicircular ridges (7′) was 149.6 μm, and the ratio (H/P′) of height to pitch was 0.29.

### Example B3

97.5 parts by mass of the translucent resin A and 2.5 parts by mass of the light diffusing agent master batch C were mixed in a dry process, and the mixture was melted and mixed in a first extrusion machine of which the cylinder temperature was set in a range from 190 to 250° C., and was supplied to the feed block. Meanwhile 67.8 parts by mass of the translucent resin B and 32.2 parts by mass of the light diffusing agent master batch B were mixed in a dry process, and the mixture was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form a base layer and the resin supplied from the second extrusion machine to the feed block would form the back surface layer (surface on the back surface side). These layers were pressed together and cooled by polishing rolls, so as to make the light diffuser plate (3′) constituted from the two layers (base layer 1.45 mm in thickness and back surface layer 0.05 mm in thickness) measuring 23.6 cm in width and 1.5 mm in thickness.

The gap between the intermediate roll and the lower roll, among the three polishing rolls, during the molding process is set larger than the thickness of the light diffuser plate, 1.5 mm, so as to allow the light diffusing particles added to the resin to protrude on the surface without being smoothed out, thus resulting in the matted surface (6) formed all over the back surface. That is, the entire surface of one surface (back surface) (3a′) of the light diffuser plate (3′) was formed as the matted surface (6). The arithmetic mean surface roughness Ra of the matted surface (6) was 1.22 μm and the mean surface irregularity interval Rsm of the matted surface (6) was 205 μm.

The intermediate roll, among the three polishing rolls, has numerous grooves of semicircular cross section formed in the form of streaks on the circumferential surface thereof. Thus a number of substantially semicircular ridges (7′) of semicircular cross section are formed to protrude over the entire surface of the base layer. That is, a number of ridges of cylindrical lens shape (8′) are formed to protrude over the entire surface of the other surface (front surface) (3b′) of the light diffuser plate (3′) (refer to FIG. 13). As shown in FIG. 13, such a surface of continuous configuration is formed as no flat portion is formed between the adjacent substantially semicircular ridges (7′). The height (H) of the substantially semicircular ridges (7′) was 68.5 μm, the pitch (P′) between adjacent substantially semicircular ridges (7′) was 279.6 μm, and the ratio (H/P′) of height to pitch was 0.24.

### Comparative Example B1

97.5 parts by mass of the translucent resin A and 2.5 parts by mass of the light diffusing agent master batch C were mixed in a dry process, and the mixture was melted and mixed in a first extrusion machine of which the cylinder temperature was set in a range from 190 to 250° C., and was supplied to the feed block. Meanwhile the translucent resin B was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form a base layer and the resin supplied from the second extrusion machine to the feed block would form the back surface layer (surface on the back surface side). These layers were pressed together and cooled by polishing rolls, so as to make the light diffuser plate (3′) constituted from the two layers (base layer 1.43 mm in thickness and back surface layer 0.07 mm in thickness) measuring 23.0 cm in width and 1.5 mm in thickness.

The gap between the intermediate roll and the lower roll, among the three polishing rolls, during the molding process was set larger than the thickness of the light diffuser plate, 1.5 mm, although no light diffusing particles were added to the translucent resin B supplied to the second extrusion machine and therefore protrusions of the light diffusing particles were not formed, thus resulting in a substantially smooth surface all over the back surface layer. That is, the entire surface of one surface (back surface) (3a′) of the light diffuser plate (3′) was substantially smooth. The back surface (3a′) of the light diffuser plate had an arithmetic mean surface roughness Ra of 0.13 μm, while the mean surface irregularity interval Rsm could not be measured (Rsm was less than the measurable limit of 0.04 μm)

The intermediate roll, among the three polishing rolls, had a number of grooves of semicircular cross section formed on the circumferential surface thereof. Thus a number of substantially semicircular ridges (7′) of semicircular cross section were formed over the entire surface of the base layer. That is, a number of ridges of cylindrical lens shape (8′) were formed to protrude over the entire surface of the other surface (front surface) (3b′) of the light diffuser plate (3′) (refer to FIGS. 9 and 10). The height (H) of the substantially semicircular ridges (7′) was 37.4 μm, the pitch (P′) between adjacent substantially semicircular ridges (7′) was 102.8 μm, and the ratio (H/P′) of height to pitch was 0.36.

### Comparative Example B2

99.8 parts by mass of the translucent resin A and 0.2 parts by mass of the light diffusing agent D were mixed in a dry process, and the mixture was melted and mixed in a first extrusion machine of which the cylinder temperature was set in a range from 190 to 250° C., and was supplied to the feed block. Meanwhile the translucent resin B was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form a base layer and the resin supplied from the second extrusion machine to the feed block would form the back surface layer (surface on the back surface side). These layers were pressed together and cooled by polishing rolls, so as to make the light diffuser plate (3′) constituted from the two layers (base layer 1.42 mm in thickness and back surface layer 0.08 mm in thickness) measuring 22.8 cm in width and 1.5 mm in thickness.

The gap between the intermediate roll and the lower roll, among the three polishing rolls, during the molding process was set larger than the thickness of the light diffuser plate, 1.5 mm, although no light diffusing particles were added to the translucent resin B supplied to the second extrusion machine and therefore protrusions of the light diffusing particles were not formed, thus resulting in a substantially smooth surface all over the back surface layer. That is, the entire surface of one surface (back surface) (3a′) of the light diffuser plate (3′) was substantially smooth. The back surface (3a′) of the light diffuser plate had an arithmetic mean surface roughness Ra of 0.11 μm, while the mean surface irregularity interval Rsm could not be measured (Rsm was less than the measurable limit of 0.04 μm)

The intermediate roll, among the three polishing rolls, had a number of grooves of semicircular cross section formed on the circumferential surface thereof. Thus a number of semicircular ridges (7′) of semicircular cross section were formed over the entire surface of the base layer. That is, a number of ridges of cylindrical lens shape (8′) were formed over the entire surface of the other surface (front surface) (3b′) of the light diffuser plate (3′) (refer to FIGS. 9 and 10). The height (H) of the substantially semicircular ridges (7′) was 46.2 μm, the pitch (P′) between adjacent substantially semicircular ridges (7′) was 149.6 μm, and the ratio (H/P′) of height to pitch was 0.31.

### Comparative Example B3

99.8 parts by mass of the translucent resin A and 0.2 parts by mass of the light diffusing agent D were mixed in a dry process, and the mixture was melted and mixed in a first extrusion machine of which the cylinder temperature was set in a range from 190 to 250° C., and was supplied to the feed block. Meanwhile the translucent resin B was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form a base layer and the resin supplied from the second extrusion machine to the feed block would form the back surface layer (surface on the back surface side). These layers were pressed together and cooled by polishing rolls, so as to make the light diffuser plate (3′) constituted from the two layers (base layer 1.43 mm in thickness and back surface layer 0.07 mm in thickness) measuring 23.0 cm in width and 1.5 mm in thickness.

The gap between the intermediate roll and the lower roll, among the three polishing rolls, during the molding process was set larger than the thickness of the light diffuser plate, 1.5 mm, although no light diffusing particles were added to the translucent resin B supplied to the second extrusion machine and therefore protrusions of the light diffusing particles were not formed, thus resulting in a substantially smooth surface all over the back surface layer. That is, the entire surface of one surface (back surface) (3a′) of the light diffuser plate (3′) was substantially smooth. The back surface (3a′) of the light diffuser plate had an arithmetic mean surface roughness Ra of 0.06 μm, while the mean surface irregularity interval Rsm could not be measured (Rsm was less than the measurable limit of 0.04 μm)

Since the three polishing rolls were all mirror-finished on the circumferential surface thereof, the entire surface of the other surface (front surface) (3b′) of the light diffuser plate (3′) was smooth. That is, the substantially semicircular ridges (7′) were not formed on the other surface (front surface) (3b′ of the light diffuser plate (3′)

### Comparative Example B4

97.5 parts by mass of the translucent resin A and 2.5 parts by mass of the light diffusing agent master batch C were mixed in a dry process, and the mixture was melted and mixed in a first extrusion machine of which the cylinder temperature was set in a range from 190 to 250° C., and was supplied to the feed block. Meanwhile 67.8 parts by mass of the translucent resin B and 32.2 parts by mass of the light diffusing agent master batch B were mixed in a dry process, and the mixture was melted and mixed in a second extrusion machine of which the cylinder temperature was set in a range from 190 to 250° C., and was supplied to the feed block.

A coextrusion molding operation was carried out by using a multi-manifold die at an extrusion temperature of 250° C., so that the resin supplied from the first extrusion machine to the feed block would form a base layer and the resin supplied from the second extrusion machine to the feed block would form the back surface layer (surface on the back surface side). These layers were pressed together and cooled by polishing rolls, so as to make the light diffuser plate (3′) constituted from the two layers (base layer 1.43 mm thick and back surface layer 0.07 mm thick) measuring 23.2 cm in width and 1.5 mm in thickness.

The gap between the intermediate roll and the lower roll, among the three polishing rolls, during the molding process was set larger than the thickness of the light diffuser plate, 1.5 mm, so as to allow the light diffusing particles added to the resin to protrude on the surface without being smoothed out, thus resulting in the matted surface (6) formed all over the back surface. That is, the entire surface of one surface (back surface) (3a′) of the light diffuser plate (3′) was formed as the matted surface (6). The matted surface (6) had an arithmetic mean surface roughness Ra of 1.23 μm and a mean surface irregularity interval Rsm of 201 μm.

The intermediate roll, among the three polishing rolls, had a number of grooves of semicircular cross section formed in the form of streaks on the circumferential surface thereof. Thus a number of substantially semicircular ridges (7′) of semicircular cross section were formed to protrude over the entire surface of the base layer. That is, a number of ridges of cylindrical lens shape (8′) were formed over the entire surface to protrude on the other surface (front surface) (3b′) of the light diffuser plate (3′) (refer to FIGS. 9 and 10). The height (H) of the substantially semicircular ridges (7′) was 10.0 μm, the pitch (P′) between adjacent substantially semicircular ridges (7′) was 62.8 μm, and the ratio (H/P′) of height to pitch was 0.16.

The light diffuser plates made as described above were evaluated according to the following methods. The results of evaluation are shown in Table B1.

TABLE B1

| | | | Properties of | | | | | | | |
|---|---|---|---|---|---|---|---|---|---|---|
| | Properties of | | Substantially | | | | Total light | Diffusion rate | Uniformity | Annoying |
| | matted surface | | semicircular ridge | | | | transmittance | D of light | of | noise |
| | Ra | | Pitch P | Height | | | of light diffuser | diffuser plate | luminance | suppressing |
| | (μm) | Rsm (μm) | (μm) | (H) | H/P | E (μm) | plate Tt (%) | (%) | (%) | performance |
| Example 1 | B1.10 | B202 | B102.4 | B35.2 | B0.34 | B4.5 | B65.2 | B34.4 | B94.1 | A |
| Example 2 | B1.21 | B210 | B149.6 | B43.8 | B0.29 | B7.7 | B68.1 | B32.5 | B92.5 | A |
| Example 3 | B1.22 | B205 | B279.6 | B68.5 | B0.24 | B0 | B68.6 | B26.2 | B93.2 | A |
| Comparative | B0.13 | Unable to | B102.8 | B37.4 | B0.36 | B6.4 | B64.7 | B32.6 | B93.8 | C |
| Example 1 | | measure | | | | | | | | |
| Comparative | B0.11 | Unable to | B149.6 | B46.2 | B0.31 | B5.5 | B68.0 | B28.7 | B92.4 | C |
| Example 2 | | measure | | | | | | | | |
| Comparative | B0.06 | Unable to | — | — | — | — | B79.1 | B30.7 | B80.7 | C |
| Example 3 | | measure | | | | | | | | |
| Comparative | B1.23 | B201 | B62.8 | B10.0 | B0.16 | B23.7 | B75.3 | B31.2 | B84.8 | A |
| Example 4 | | | | | | | | | | |

E: Groove width of flat portion

### Measurement of Total Light Transmittance

Total light transmittance (%) of the light diffuser plate was measured by using a light transmittance meter (“HR-100” manufactured by Murakami Color Engineering Laboratory) in accordance to JIS K7361-1 (1997). Measurement was made by directing the front surface of the light diffuser plate whereon the ridges were formed toward an integrating sphere and scanning across the pitch in the right to left direction.

### Evaluation of Uniformity of Luminance

A lamp box made of polycarbonate (having a plurality of fluorescent tubes disposed with a space from each other therein) was prepared by removing a liquid crystal panel, various optical films and a light diffuser plate from a 20-inch liquid crystal television set available in the market. The light diffuser plate made in the process of the Examples or the Comparative Examples was secured onto the lamp box to make contact with the front face of the frame, so as to close the aperture of the lamp box. Then luminance of light emitted by the experimental setup with the light diffuser plate set thereon was measured with a luminance meter “Eye Scale-3WS” manufactured by I-System Co., Ltd. Uniformity of luminance (%) was calculated from the minimum value of luminance “C1” and the maximum value of luminance “C2” by the following equation.

Uniformity of luminance (%)=C1/C2×100

The luminance was measured as follows. A 20-inch liquid crystal television set was placed on the floor of a dark room where temperature and humidity were controlled so as to be constant (temperature 25.0° C., humidity 50.0%) with the front surface side facing upward (back surface on the floor). A camera was disposed above the liquid crystal television set facing downward so as to capture the entire front surface of the liquid crystal television set. The distance between the front surface of the liquid crystal television set and the camera was set to 65.0 cm, and the measuring conditions were set to a shutter speed of 1/500 seconds, a gain of 1 and an aperture of 16. Measurements were taken in a region of 60 mm by 60 mm around the center of the front surface of the liquid crystal television set, and uniformity of luminance (%) was calculated from the minimum value of luminance and the maximum value of luminance among the measured values.

The 20-inch liquid crystal television set obtained in the market, that was used in Examples B1 to B3 and Comparative Examples B1 to B4, had 12 light sources, a distance (L) between adjacent light sources of 26.0 mm, a diameter of the light source of 4.0 mm, a distance (d) between the light diffuser plate and the light sources of 12.0 mm and a distance (f) between the light sources and the reflector (bottom surface of the lamp box) of 11.0 mm (refer to FIG. 8).

### Measurement of Diffusion Ratio D of Light Diffuser Plate

Diffusion ratio D (%) was determined by measuring the changes in the intensity distribution of the transmitted light with light incident on the light diffuser plate (made in the Examples or the Comparative Examples) at a specified angle, by using an automatic scanning photometer (“GP230” manufactured by Murakami Color Engineering Laboratory). The back surface of the light diffuser plate was directed toward the light source and the front surface of the light diffuser plate was directed toward an integrating sphere. Measurement was made by scanning across the pitch of the substantially semicircular ridges while setting the diameter of the light beam to 1.7 mm, setting the intensity of the emitted light and sensitivity of receiving the light constant and setting the incident angle of light to 0 degrees.

### Evaluation of Annoying Noise Preventing Performance

A lamp box made of polycarbonate (having a plurality of fluorescent tubes disposed therein with a space from each other) was prepared by removing a liquid crystal panel and a light diffuser plate from a 20-inch liquid crystal television set available in the market, the same as that used in the evaluation of uniformity of luminance. The light diffuser plate made in the process of the Examples or the Comparative Examples was secured onto the lamp box to make contact with the front face of the frame, so as to close the aperture of the lamp box. Then the liquid crystal panel was reset on the lamp box, so as to reconstruct the liquid crystal television set. The liquid crystal television set was held with both hands in the normal state of vertical posture, and was shaken back and forth with a frequency of about 180 times a minute, to see whether annoying noise was generated or not. A rating of “A” was given when annoying noise was not generated, “B” was given when slight annoying noise was generated, and “C” was given when conspicuous annoying noise was generated.

### Measurement of Arithmetic Mean Surface Roughness Ra

Arithmetic mean surface roughness Ra was measured in accordance to JIS B0601-2001. By using a surface roughness meter (“SJ-201P” manufactured by Mitsutoyo Corporation) that was set to a cutoff value of 2.5×5 and an automatic measuring range, the arithmetic mean surface roughness Ra of the matted surface of the light diffuser plate was measured.

### Measurement of Mean Surface Irregularity Interval Rsm

Mean surface irregularity interval Rsm was measured in accordance to JIS B0601-2001. By using a surface roughness meter (“SJ-201P” manufactured by Mitsutoyo Corporation) that was set to a cutoff value of 2.5×5 and an automatic measuring range, the mean surface irregularity interval Rsm of the matted surface of the light diffuser plate was measured.

As can be seen from the table, the surface emission light source apparatus and the liquid crystal display apparatus constituted by using the light diffuser plates of Examples B1 to B3 of the present invention were capable of suppressing the generation of annoying noise satisfactorily.

Those of Comparative Examples B1 to B3, that were out of the scope of the present invention, were unable to suppress the generation of annoying noise. In the case of Comparative Example B4, where the value of H/P′ was below the range specified according to the present invention, sufficient effect of suppressing the unevenness in luminance could not be achieved.

The light diffuser plate of the present invention can be preferably used as the light diffuser plate for a surface emission light source apparatus, but is not restricted to this application. The surface emission light source apparatus of the present invention can be preferably used as the backlight for a liquid crystal display apparatus, but is not restricted to this application.

1. A surface emission light source apparatus comprising a plurality of light sources disposed at a distance from each other in a lamp box, that is made of a resin and has an open front side, and a light diffuser plate that is made of a resin and is disposed on the front side of the frame of the lamp box so as to close the opening of the lamp box, wherein at least a part of the back surface of the light diffuser plate that makes contact with the front surface of the frame is formed as a matted surface, the matted surface has an arithmetic mean surface roughness Ra in a range from 0.8 to 15 μm and a mean surface irregularity interval Rsm in a range from 100 to 300 μm.

2. The surface emission light source apparatus according to claim 1, wherein a plurality of triangular ridges having a triangular cross section is disposed to protrude on the front surface of the light diffuser plate, while the vertex angle of the triangular ridges is set in a range from 40 to 150 degrees and the pitch between adjacent triangular ridges is set in a range from 10 to 500 μm.

3. The surface emission light source apparatus according to claim 1, wherein a plurality of substantially semicircular ridges having a substantially semicircular cross section is formed to protrude on the front surface of the light diffuser plate, the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.

4. A surface emission light source apparatus comprising a plurality of light sources disposed at a distance from each other in a lamp box, that is made of a resin and has an open front side, and a light diffuser plate that is made of a resin and is disposed on the front side of the frame of the lamp box so as to close the opening of the lamp box, wherein the entire back surface of the light diffuser plate is formed as a matted surface, the matted surface has an arithmetic mean surface roughness Ra in a range from 0.8 to 15 μm and a mean surface irregularity interval Rsm in a range from 100 to 300 μm.

5. The surface emission light source apparatus according to claim 4, wherein a plurality of triangular ridges having a triangular cross section is disposed to protrude on the front surface of the light diffuser plate, while the vertex angle of the triangular ridges is set in a range from 40 to 150 degrees, and the pitch between adjacent triangular ridges is set in a range from 10 to 500 μm.

6. The surface emission light source apparatus according to claim 4, wherein a plurality of substantially semicircular ridges having a substantially semicircular cross section is formed to protrude on the front surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.

7. The surface emission light source apparatus according to claim 2, wherein the triangular ridges are ridges of prism shape, the light sources are linear light sources, and the ridges of prism shape are disposed so that the longitudinal direction thereof substantially agrees with the longitudinal direction of the linear light sources.

8. The surface emission light source apparatus according to claim 3, wherein the substantially semicircular ridges are ridges of cylindrical lens shape, the light sources are linear light sources, and the ridges of cylindrical lens shape are disposed so that the longitudinal direction thereof substantially agrees with the longitudinal direction of the linear light sources.

9. The surface emission light source apparatus according to claim 1, wherein total light transmittance of the light diffuser plate is in a range from 55 to 85%.

10. A liquid crystal display apparatus comprising the surface emission light source apparatus according to claim 1 and a liquid crystal display panel disposed on the front side of the surface emission light source apparatus.

11. A light diffuser plate made of a resin with at least a peripheral portion of one surface thereof being formed as a matted surface, wherein the matted surface has an arithmetic mean surface roughness Ra in a range from 0.8 to 15 μm and a mean surface irregularity interval Rsm in a range from 100 to 300 μm.

12. The light diffuser plate according to claim 11, wherein a plurality of triangular ridges having a triangular cross section is disposed to protrude on the other surface of the light diffuser plate, the triangular ridges have a vertex angle set in a range from 40 to 150 degrees and the pitch between adjacent triangular ridges is set in a range from 10 to 500 μm.

13. The light diffuser plate according to claim 11, wherein a plurality of substantially semicircular ridges having a substantially semicircular cross section is formed to protrude on the other surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.

14. A light diffuser plate made of a resin with the entire surface on one surface thereof being formed as a matted surface, wherein the matted surface has an arithmetic mean surface roughness Ra in a range from 0.8 to 15 μm and a mean surface irregularity interval Rsm in a range from 100 to 300 μm.

15. The light diffuser plate according to claim 14, wherein a plurality of triangular ridges having a triangular cross section is disposed to protrude on the other surface of the light diffuser plate, while the triangular ridges have a vertex angle set in a range from 40 to 150 degrees and the pitch between adjacent triangular ridges is set in a range from 10 to 500 μm.

16. The light diffuser plate according to claim 14, wherein a plurality of substantially semicircular ridges having a substantially semicircular cross section is formed to protrude on the other surface of the light diffuser plate, while the pitch (P) between adjacent substantially semicircular ridges is set in a range from 10 to 500 μm, the height H of the substantially semicircular ridges is set in a range from 3 to 500 μm, and the ratio (H/P) of the height to the pitch is set in a range from 0.2 to 0.8.
